(19) United States
(12) Patent Application Publication
(10) Pub. No.: US 2025/0212524 A1
(43) Pub. Date: Jun. 26, 2025

(54) HYBRID HIGH-PERFORMANCE CELL WITH BACKSIDE CONTACT

(71) Applicant: QUALCOMM Incorporated, San Diego, CA (US)

(72) Inventors: Shreesh NARASIMHA, Charlotte, NC (US); Yan SUN, San Diego, CA (US); Basanth JAGANNATHAN, Shrub Oak, NY (US); Satadru SARKAR, San Diego, CA (US)

(21) Appl. No.: 18/391,170

(22) Filed: Dec. 20, 2023

(51) Int. Cl. H01L 27/02; H01L 23/522; H01L 23/528

(52) U.S. Cl. CPC H10D 89/10; H01L 23/5226; H01L 23/5286

(57) ABSTRACT

A chip includes a first cell and a second cell. The first cell includes a first diffusion region extending in a first direction, and a first backside contact coupled to a bottom surface of the first diffusion region. The second cell includes a second diffusion region extending in the first direction, wherein the second diffusion region is wider than the first diffusion region in a second direction perpendicular to the first direction, and a second backside contact coupled to a bottom surface of the second diffusion region. The chip also includes a power rail extending under the first cell and the second cell in the first direction, wherein the power rail is coupled to the first backside contact and the second backside contact.

### BACKGROUND

### Field

Aspects of the present disclosure relate generally to chip layout, and more particularly, to chips with backside contacts.

### Background

A chip may include many cells (e.g., thousands to millions of cells) laid out on the chip. Each cell may include one or more transistors that are arranged to provide a circuit (e.g., a driver, a logic gate, combinational logic, a latch, or another type of circuit). The layout of each cell may be specified in a standard cell library that defines the layouts for various types of cells that can be placed (i.e., laid out) on the chip.

### SUMMARY

The following presents a simplified summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

A first aspect relates to a chip. The chip includes a first cell and a second cell. The first cell includes a first diffusion region extending in a first direction, and a first backside contact coupled to a bottom surface of the first diffusion region. The second cell includes a second diffusion region extending in the first direction, wherein the second diffusion region is wider than the first diffusion region in a second direction perpendicular to the first direction, and a second backside contact coupled to a bottom surface of the second diffusion region. The chip also includes a power rail extending under the first cell and the second cell in the first direction, wherein the power rail is coupled to the first backside contact and the second backside contact.

A second aspect relates to a chip. The chip includes a first cell and a second cell. The first cell includes a first diffusion region extending in a first direction, and a second diffusion region extending in the first direction. The second cell includes a third diffusion region extending in the first direction, and a fourth diffusion region extending in the first direction, wherein each of the third diffusion region and the fourth diffusion region is wider than each of the first diffusion region and the second diffusion region in a second direction perpendicular to the first direction. The chip also includes first power rail extending under the first cell and the second cell in the first direction, wherein the first power rail is coupled to a bottom surface of the first diffusion region and a bottom surface of the third diffusion region. The chip also includes a second power rail extending under the first cell and the second cell in the first direction, wherein the second power rail is coupled to a bottom surface of the second diffusion region and a bottom surface of the fourth diffusion region.

A third aspect relates to a chip. The chip includes a first cell, a second cell, and a third cell. The first cell includes a first diffusion region extending in a first direction, and a second diffusion region extending in the first direction. The second cell includes a third diffusion region extending in the first direction, and a fourth diffusion region extending in the first direction. The third cell includes a fifth diffusion region extending in the first direction, and a sixth diffusion region extending in the first direction, wherein each of the fifth diffusion region and the sixth diffusion region is wider than each of the first diffusion region, the second diffusion region, the third diffusion region, and the fourth diffusion region in a second direction perpendicular to the first direction. The chip also includes a first power rail extending under the first cell and the third cell in the first direction, wherein the first power rail is coupled to a bottom surface of the first diffusion region and a bottom surface of the fifth diffusion region. The chip also includes a second power rail extending under the first cell and the third cell in the first direction, wherein the second power rail is coupled to a bottom surface of the second diffusion region. The chip also includes a third power rail extending under the second cell and the third cell in the first direction, wherein the third power rail is coupled to a bottom surface of the third diffusion region and a bottom surface of the sixth diffusion region. The chip further includes a fourth power rail extending under the second cell and the third cell in the first direction, wherein the fourth power rail is coupled to a bottom surface of the fourth diffusion region.

A fourth aspect relates to a chip. The chip includes a first diffusion region extending in a first direction, a second diffusion region extending in the first direction, a third diffusion region extending in the first direction, and a fourth diffusion region extending in the first direction, wherein each of the third diffusion region and the fourth diffusion region is wider than each of the first diffusion region and the second diffusion region in a second direction perpendicular to the first direction. The chip also includes a first power rail extending under the first diffusion region in the first direction, wherein the first power rail is coupled to a bottom surface of the first diffusion region and a bottom surface of the third diffusion region. The chip further includes a second power rail extending under the second diffusion region in the first direction, wherein the second power rail is coupled to a bottom surface of the second diffusion region and a bottom surface of the fourth diffusion region.

A fifth aspect relates to a chip. The chip includes a first diffusion region extending in a first direction, a second diffusion region extending in the first direction, a third diffusion region extending in the first direction, a fourth diffusion region extending in the first direction, a fifth diffusion region extending in the first direction, and a sixth diffusion region extending in the first direction, wherein each of the fifth diffusion region and the sixth diffusion region is wider than each of the first diffusion region, the second diffusion region, the third diffusion region, and the fourth diffusion region in a second direction perpendicular to the first direction. The chip also includes a first power rail extending under the first diffusion region in the first direction, wherein the first power rail is coupled to a bottom surface of the first diffusion region and a bottom surface of the fifth diffusion region. The chip also includes a second power rail extending under the second diffusion region in the first direction, wherein the second power rail is coupled to a bottom surface of the second diffusion region. The chip also includes a third power rail extending under the third diffusion region in the first direction, wherein the third power rail is coupled to a bottom surface of the third diffusion region and a bottom surface of the sixth diffusion region. The chip further includes a fourth power rail extending under the fourth diffusion region in the first direction, wherein the fourth power rail is coupled to a bottom surface of the fourth diffusion region.

### BRIEF DESCRIPTION OF THE DRAWINGS

FIG. 1A shows a side view of an example of a chip including a transistor, multiple topside layers, and multiple backside layers according to certain aspects of the present disclosure.

FIG. 1B shows a side view of the chip of FIG. 1A further including a via disposed between a backside contact and a backside metal layer according to certain aspects of the present disclosure.

FIG. 1C shows a side view of the transistor of FIG. 1A implemented with a gate-all-around field effect transistor (FET) according to certain aspects of the present disclosure.

FIG. 1D shows a side view of the chip of FIG. 1C further including a via disposed between a backside contact and a backside metal layer according to certain aspects of the present disclosure.

FIG. 1E shows a perspective view of the transistor implemented with the gate-all-around FET according to certain aspects of the present disclosure.

FIG. 1F shows a perspective view of the transistor implemented with a FinFET according to certain aspects of the present disclosure.

FIG. 2 shows a top view of a high-density (HD) cell and a high-performance (HP) cell according to certain aspects of the present disclosure.

FIG. 3 illustrates an example in which HD cells are swapped with HP cells according to certain aspects of the present disclosure.

FIG. 4A shows a top view of the HD cell and a hybrid HP cell according to certain aspects of the present disclosure.

FIG. 4B shows an exemplary layout of diffusion regions in the HD cell and the hybrid HP cell of FIG. 4A according to certain aspects of the present disclosure.

FIG. 4C shows another exemplary layout of diffusion regions in the HD cell and the hybrid HP cell of FIG. 4A according to certain aspects of the present disclosure.

FIG. 5 illustrates an example in which HD cells are swapped with hybrid HP cells according to certain aspects of the present disclosure.

FIG. 6 is a plot illustrating an example of area and load capacitance versus percentage of hybrid HP cells according to certain aspects of the present disclosure.

FIG. 7 is a plot illustrating another example of area and load capacitance versus percentage of hybrid HP cells according to certain aspects of the present disclosure.

FIG. 8 shows an example of rails formed in a topside metal layer according to certain aspects of the present disclosure.

FIG. 9 shows an example of rails formed in a backside metal layer and extending below a first HD cell, a second HD cell, and a hybrid HP cell according certain aspects of the present disclosure.

FIG. 10A shows an example of backside vias disposed between backside contacts and rails formed in the backside metal layer according to certain aspects of the present disclosure.

FIG. 10B shows a top view of the backside vias without the backside contacts of FIG. 10A according to certain aspects of the present disclosure.

FIG. 10C shows another example of backside vias disposed between backside contacts and rails formed in the backside metal layer according to certain aspects of the present disclosure.

FIG. 10D shows a top view of the backside vias without the backside contacts of FIG. 10C according to certain aspects of the present disclosure.

FIG. 11A shows an example of gates extending across diffusion regions in the first HD cells, the second HD cell, and the hybrid HP cell according to certain aspects of the present disclosure.

FIG. 11B shows an example in which the gates of FIG. 11A are cut according to certain aspects of the present disclosure.

FIG. 11C shows another example in which the gates of FIG. 11A are cut according to certain aspects of the present disclosure.

FIG. 12 shows an example of metal tracks for signal routing formed from a topside metal layer according to certain aspects of the present disclosure.

FIG. 13 shows a block diagram of a NAND gate according to certain aspects of the present disclosure.

FIG. 14A shows an exemplary layout of contacts and vias for implementing the NAND gate of FIG. 13 using a hybrid HP cell according to certain aspects of the present disclosure.

FIG. 14B shows an exemplary layout of metal routing in a first topside metal layer for the NAND gate of FIG. 13 according to certain aspects of the present disclosure.

FIG. 14C shows an exemplary layout of metal routing in a second topside metal layer for the NAND gate of FIG. 13 according to certain aspects of the present disclosure.

FIG. 14D shows an example of backside power routing for the hybrid HP cell including a first rail according to certain aspects of the present disclosure.

FIG. 14E shows an example of a via disposed between a backside contact and the first rail of FIG. 14D according to certain aspects of the present disclosure.

FIG. 14F shows another example of backside power routing for the hybrid HP cell including a second rail according to certain aspects of the present disclosure.

FIG. 14G shows an example of vias disposed between backside contacts and the second rail of FIG. 14F according to certain aspects of the present disclosure.

FIG. 15 is a block diagram illustrating a computer system according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

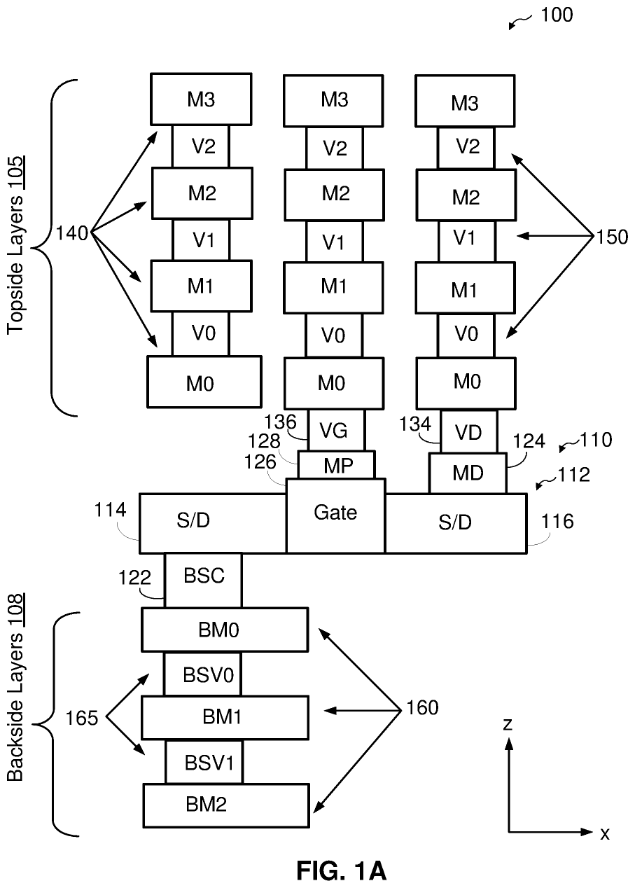

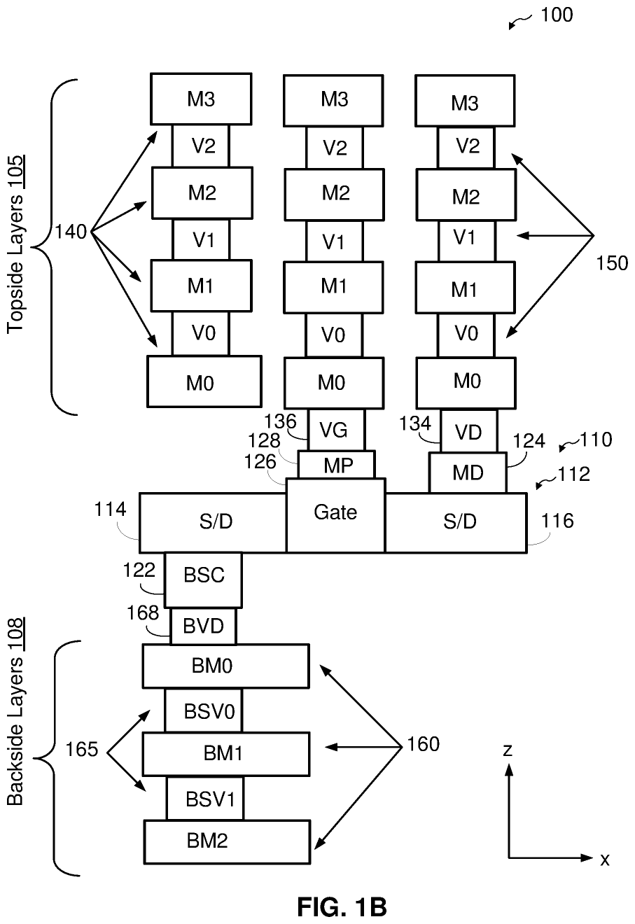

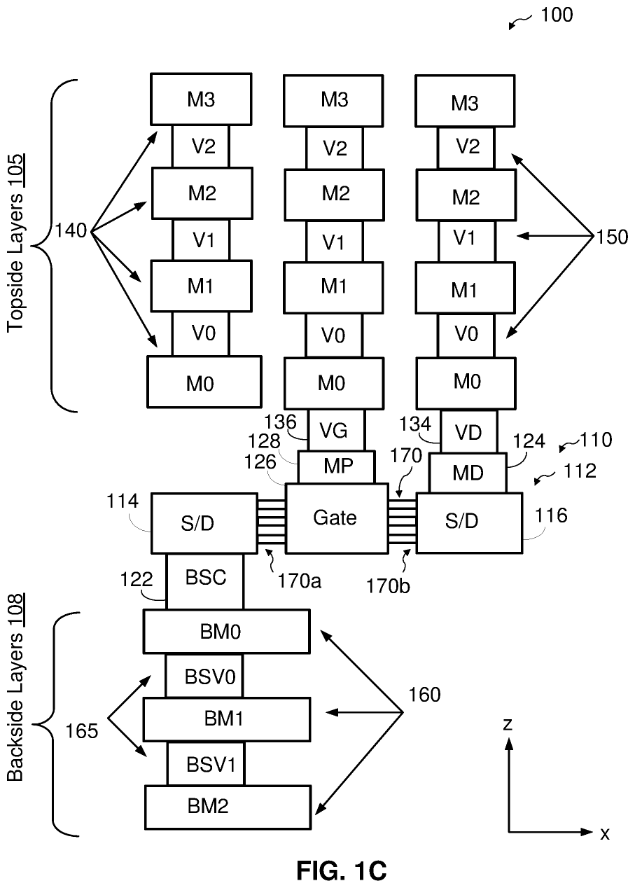

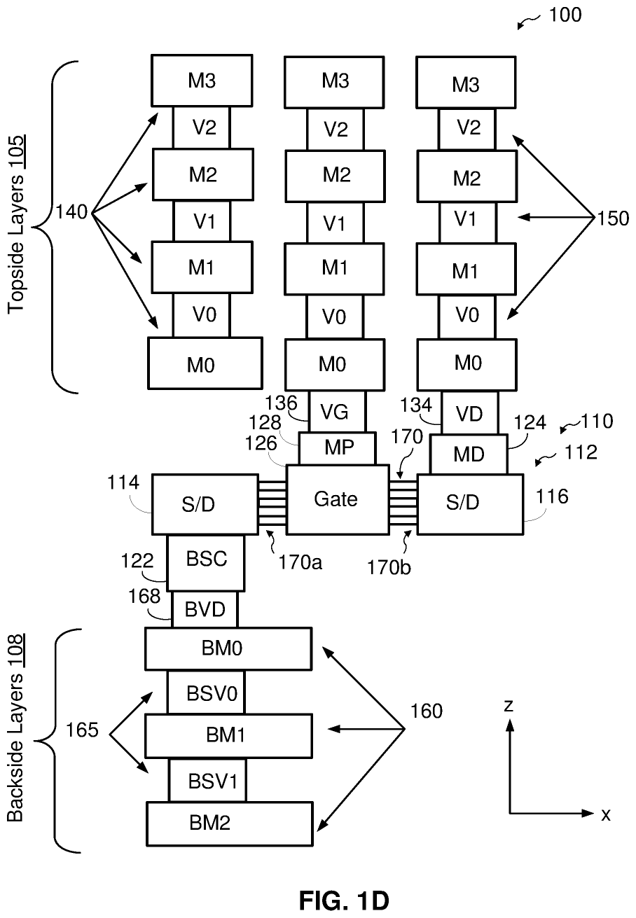

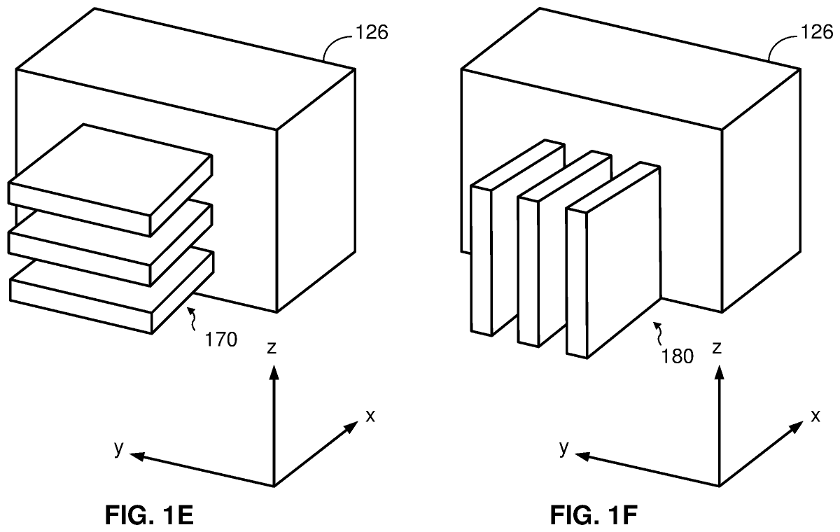

FIG. 1A shows a side view of an example of a chip 100 (e.g., a die) including a transistor 110, multiple topside layers 105, and multiple backside layers 108 according to certain aspects. Although one transistor 110 is shown in FIG. 1A for simplicity, it is to be appreciated that the chip 100 includes many transistors. As discussed further below, the transistor 110 may be implemented using a fin field-effect transistor (FinFET) process, a gate-all-around FET process, or another type of process. The topside layers 105 include layers above the transistor 110, and the backside layers 108 include layers below the transistor 110. The topside layers may also be referred to as frontside layers or another term.

In the example shown in FIG. 1A, the transistor 110 includes a diffusion region 112 and a gate 126 on the diffusion region 112. The diffusion region 112 may also be referred to as an oxide diffusion region, an active region, active diffusion, active (RX), or another term. The gate 126 may include polysilicon, a gate metal, and/or another gate material. In the example shown in FIG. 1A, a portion of the diffusion region 112 to the left of the gate 126 provides a first source/drain 114 of the transistor 110, and a portion of the diffusion region 112 to the right of the gate 126 provides a second source/drain 116 of the transistor 110. As used herein, the term “source/drain” means a source, a drain, or both a source and a drain. In this example, the gate 126 controls the conductivity between the first source/drain 114 and the second source/drain 116 based on a voltage applied to the gate 126. The transistor 110 may be a p-type transistor in which the diffusion region 112 is a p-type diffusion region, or the transistor 110 may be an n-type transistor in which the diffusion region 112 is an n-type diffusion region.

In this example, the chip 100 includes a topside contact 124 formed on a top surface of the second source/drain 116. A top surface may also be referred to as a frontside surface. The contact 124 may be formed (i.e., patterned) from a topside contact layer using, for example, lithographic and etching processes. The contact 124 may be referred to as a metal-diffusion (MD) contact, contact active (CA), or another term. The chip 100 may also include a gate contact 128 formed on the gate 126. The gate contact 128 may be referred to as a metal-poly (MP) contact or another term. The gate contact 128 may be omitted is some implementations. A topside contact may also be referred to as a frontside contact or another term.

In this example, the topside layers 105 include topside metal layers 140. A topside metal layer may also be referred to as a frontside metal layer, a metal interconnect, or another term. The topside metal layers 140 may be patterned (e.g., using lithography and etching) to provide signal routing for the transistor 110 and other transistors (not shown in FIG. 1A) integrated on the chip 100. In some implementations, the topside metal layers 140 may also be patterned to form a power distribution network including supply rails for distributing power to the transistor 110 and other transistors integrated on the chip 100. In other implementations, the power distribution network is provided using the backside layers 108 (e.g., to reduce routing congestion in the topside layers 105), as discussed further below.

In the example in FIG. 1A, the bottom-most topside metal layer among the topside metal layers 140 is referred to as metal layer M0. The topside metal layer immediately above metal layer M0 is referred to as metal layer M1, the topside metal layer immediately above metal layer M1 is referred to as metal layer M2, the topside metal layer immediately above metal layer M2 is referred to as metal layer M3, and so forth. Although four topside metal layers 140 (i.e., M0 to M3) are shown in FIG. 1A for ease of illustration, it is to be appreciated that the topside layers 105 may include additional topside metal layers above metal layer M3. It is to be appreciated that the present disclosure is not limited to the nomenclature in which the bottom-most topside metal layer is referred to as metal layer M0. For instance, in another example, the bottom-most topside metal layer may be referred to as metal layer M1 instead of metal layer M0.

The topside layers 105 also includes vias 150 that provide coupling between the topside metal layers 140. In this example, the vias V0 provide coupling between metal layer M0 and metal layer M1, the vias V1 provide coupling between metal layer M1 and metal layer M2, and the vias V2 provide coupling between metal layer M2 and metal layer M3. In the example in FIG. 1A, the chip also includes a via 136 disposed between the gate contact 128 and metal layer M0, in which the via 136 couples the gate contact 128 (and hence the gate 126) to metal layer M0. For implementations where the gate contact 128 is omitted, the via 136 may be disposed between the gate 126 and metal layer M0 without an intervening gate contact. Also, in this example, the chip 100 includes a via 134 disposed between the contact 124 and metal layer M0, in which the via 134 couples the contact 124 to metal layer M0. In some implementations, the via 134 may be omitted with the contact 124 directly contacting metal layer M0.

In certain aspects, the diffusion region 112 and the gate 126 of the transistor 110 and the topside layers 105 may be formed on a silicon substrate during fabrication. A carrier wafer (not shown) may then be bonded to the top of the chip 100 for structural support, and most or all of the silicon substrate may be grounded and/or polished off. The backside layers 108 may then be formed underneath the transistor 110 and/or any remaining portion of the silicon substrate.

In this example, the backside layers 108 include backside metal layers 160. The backside metal layers 160 may be patterned (e.g., using lithography and etching) to form a power distribution network including supply rails for distributing power to the transistor 110 and other transistors on the chip 100.

In the example in FIG. 1A, the top-most backside metal layer among the backside metal layers 160 is referred to as backside metal layer BM0. The backside metal layer immediately below backside metal layer BM0 is referred to as backside metal layer BM1, the backside metal layer immediately below backside metal layer BM1 is referred to as backside metal layer BM2, and so forth. Although three backside metal layers 160 (i.e., BM0 to BM2) are shown in FIG. 1A for ease of illustration, it is to be appreciated that the backside layers 108 may include additional metal layers below backside metal layer BM2.

In the example in FIG. 1A, the chip 100 includes a backside contact 122 formed on a bottom surface (i.e., backside surface) of the first source/drain 114. The backside contact 122 may be formed (i.e., patterned) from a backside contact layer (labeled “BSC”) using, for example, lithographic and etching processes. The backside contact 122 is used to couple the first source/drain 114 to backside metal layer BM0. In some implementations, the backside contact 122 may directly contact backside metal layer BM0, as shown in the example in FIG. 1A. In other implementations, the backside contact 122 may be coupled to backside metal layer BM0 through an intervening via. In this regard, FIG. 1B shows an example in which the chip 100 includes a backside via 168 (labeled “BVD”) disposed between the backside contact 122 and backside metal layer BM0. In this example, the via 168 provides a space between the backside contact 122 and backside metal layer BM0 in the vertical direction (i.e., z direction in FIG. 1B).

In the examples in FIG. 1A and FIG. 1B, the backside layers 108 include vias 165 that provide coupling between the backside metal layers 160. In this example, the vias 165 include a via BSV0 that provides coupling between backside metal layer BM0 and backside metal layer BM1, and a via BSV1 that provides coupling between backside metal layer BM1 and backside metal layer BM2.

In certain aspects, the topside metal layers 140 are patterned (e.g., using lithography and etching) to provide signal routing for the transistor 110 and other transistors (not shown in FIG. 1A) integrated on the chip 100, and the backside metal layers 160 are patterned to form a power distribution network including supply rails for distributing power to the transistor 110 and the other transistors integrated on the chip 100. Moving the power distribution network to the backside layers 108 can significantly reduce routing congestion compared with using the topside layers 105 for both signal routing and power distribution. The reduced congestion allows the layout of the signal routing to be better optimized (e.g., to reduce parasitic capacitances for higher performance), and allows the layout of the power distribution network to be better optimized (e.g., to reduce resistances in the power distribution network for lower current-resistor (IR) drops).

As discussed above, the transistor 110 may be implemented using a FinFET process, a gate-all-around FET process, or another type of process. FIG. 1C shows an example in which the transistor 110 is implemented using a gate-all-around FET process. In this example, the diffusion region 112 includes vertically stacked channels 170 (e.g., nanosheets) in which the gate 126 may surround each of the channels 170 on four sides. The first source/drain 114 and the second source/drain 116 may each include epitaxially grown or deposited silicon, a silicon-based material (e.g., silicon-germanium), or any combination thereof. In this example, the first source/drain 114 is coupled to a first side 170a of the channels 170, and the second source/drain 116 is coupled to a second side 170b of the channels. However, it is to be appreciated that the present disclosure is not limited to this example. FIG. 1D shows the exemplary transistor 110 of FIG. 1C in which the chip 100 includes the via 168 (labeled “BVD”) between the backside contact 122 and backside metal layer BM0. As discussed above, the via 168 provides a space between the backside contact 122 and backside metal layer BM0. FIG. 1E shows a perspective view of an example of the channels 170 and the gate 126.

FIG. 1F shows a perspective view in which the transistor 110 is implemented using a FinFET process. In this example, the diffusion region 112 includes fins 180 extending in the x direction, in which the gate 126 may surround each of the fins on three sides.

Although one gate 126 is shown in FIGS. 1A, 1B, 1C, and 1D, it is to be appreciated that the transistor 110 may include multiple gates arranged in parallel and coupled to one another (e.g., through metal layer M0). A transistor with multiple gates may be referred to as a multi-finger transistor or another term.

Transistors on the chip 100 may be organized into cells. Each cell may include one or more transistors that are arranged to provide a circuit (e.g., a driver, a logic gate, combinational logic, a latch, a flip-flop, or another type of circuit). The cells may be arranged in rows on the chip 100, in which each row of cells may be between a supply rail and a ground rail to deliver power to the cells in the row.

The layout of each cell may be specified (i.e., defined) in a standard cell library, which may be stored in a memory. The standard cell library may specify (i.e., define) the layout of each one of various cells that can be placed (i.e., laid out) on the chip 100 for a particular process. The chip 100 may include multiple instances of a particular cell defined in the standard cell library. The layout of each cell defined in the standard cell library may include the layout of gates (e.g., poly gates), diffusion regions, and contacts in the cell. The standard cell library may also specify the layouts of filler cells, decap cells, endcap cells, and the like.

In certain aspects, cells in the standard cell library may be grouped into high-density (HD) cells and high-performance HP cells, where an HP cell has a greater height than an HD cell, as discussed further below. The standard cell library may define an HP cell and an HD cell for each one of various circuits that can be integrated on the chip 100. For example, the standard cell library may define an HP cell and an HD cell for a driver (e.g., a complementary inverter), a logic gate, or another type of circuit. In this example, the HD cell may be configured to consume less power and less area than the HP cell while the HP cell may be configured to provide higher performance (e.g., greater drive strength) than the HD cell. This may be achieved by providing the HD cell with smaller transistors for reduced power consumption and providing the HP cell with larger transistors for higher performance (e.g., greater drive strength). In certain aspects, the standard cell library includes an HD cell library and an HP library where the HD cell library defines the layouts of HD cells that may be placed on the chip 100 and the HP cell library defines the layouts of HP cells that may be placed on the chip 100.

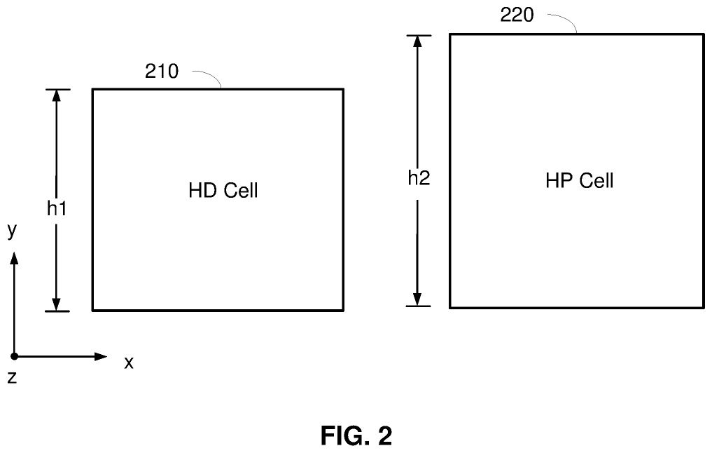

FIG. 2 shows a top view block diagram of an HD cell 210 and an HP cell 220 to illustrate an exemplary size comparison of the HD cell 210 and the HP cell 220. In FIG. 2, the z direction is directed out of the page. In this example, the HD cell 210 has a first height (labeled “h1”) in the y direction and the HP cell 220 has a second height (labeled “h2”) in the y direction, in which the second height is greater than the first height (i.e., h2>h1). For example, the second height may be between 1.1 to 1.4 times the first height. In another example, the second height may be between 1.2 to 1.4 times the first height. However, it is to be appreciated that the present disclosure is not limited to these examples. The second height may be greater than the first height due to larger transistors in the HP cell for higher performance.

A large circuit (e.g., a functional block) may be implemented on the chip 100 using HD cells from the HD cell library or using HP cells from the HP cell library based on one or more considerations such as frequency, power, and/or area. For example, if the circuit does not require high performance, then the circuit may be implemented using HD cells for low power and smaller area. If the circuit requires higher performance (e.g., higher operating frequency), then the circuit may be implemented using HP cells to achieve the higher performance at the expense of higher power and larger area. The circuit may be a functional block in a digital signal processor (DSP), a central processing unit (CPU) core, etc.

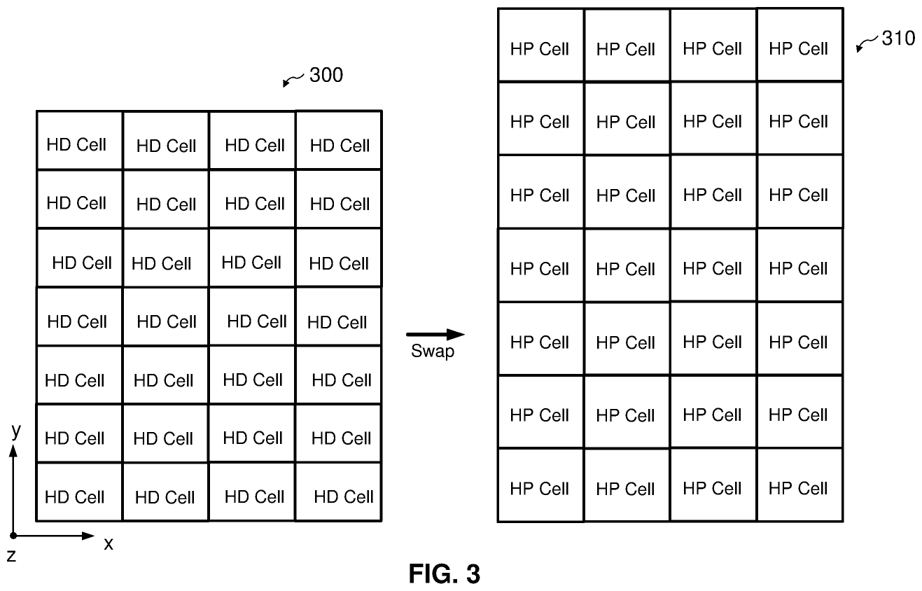

FIG. 3 shows an example in which the circuit is initially implemented using a group of HD cells 300 arranged in rows to conserve power and area. In this example, a determination may be made that the circuit does not meet a desired performance level (e.g., operating frequency) based on, for example, a timing analysis of the circuit. In order to meet the desired performance level, all the HD cells in the group of HD cells 300 may be swapped with corresponding HP cells, resulting in the group of HP cells 310 shown in FIG. 3. In this example, swapping all of the HD cells with the HP cells increases the power and area of the circuit. For example, if the height of each of the HP cells is equal to 1.25 times the height of each of the HD cells, then swapping the HD cells with the HP cells increases the area of the circuit by approximately 25 percent. Although the HD cells and the HP cells are shown having uniform lengths in the x direction for simplicity, it is to be appreciated that this need not be the case. It is to be appreciated that the boundaries of the HD cells and the HP cells shown in FIG. 3 are for conceptual illustration only. After these cells are laid out and fabricated on the chip, the boundaries of these cells may or may not be visible.

In many cases, the failure of the circuit (e.g., functional block) to meet a desired performance level (e.g., operating frequency) using the HD cells may be due to a small percentage of the HD cells (e.g., due to HD cells in a critical path of the circuit). In these cases, only a small percentage of the HD cells need to be swapped with corresponding HP cells to meet the desired performance level. However, the current approach illustrated in FIG. 3 requires swapping all of the HD cells in the circuit with corresponding HP cells even when only a small percentage of the HD cells need to be swapped for the circuit to meet the desired performance level. This is because placing one or more HP cells within the circuit would disrupt the row arrangements of the HD cells in the circuit and cause routing problems due to the different heights of the one or more HP cells and the HD cells. In these cases, swapping all of the HD cells in the circuit with HP cells results in a larger increase in area and power than necessary for the circuit to achieve the desired performance level.

To address the above, aspects of the present disclosure provide hybrid HP cells that allow a portion of the HD cells in a circuit (e.g., a small percentage of the HD cells) to be swapped with the hybrid HP cells to meet a desired performance level for the circuit (e.g., functional block). Since only a portion of the HD cells are swapped instead of swapping all of the HD cells, the hybrid HP cells allow the circuit to meet the desired performance level with higher area and power efficiency compared with the approach illustrated in FIG. 3 in which all the HD cells are swapped with HP cells.

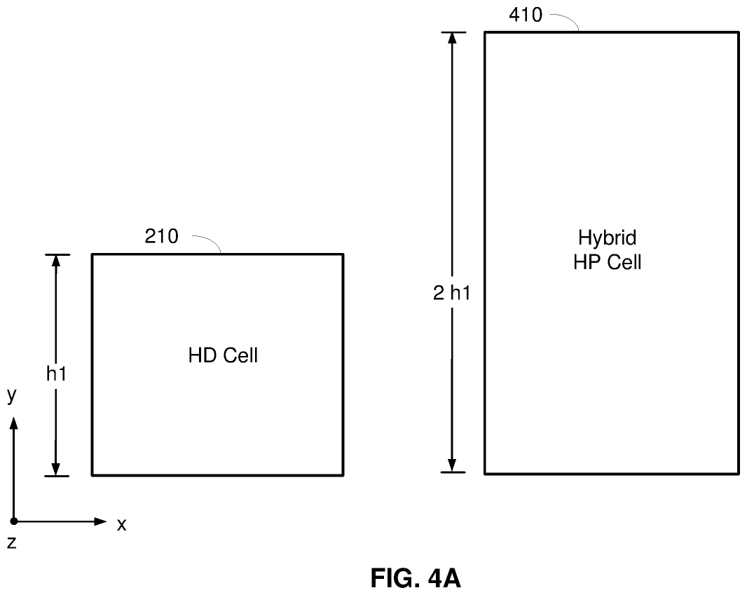

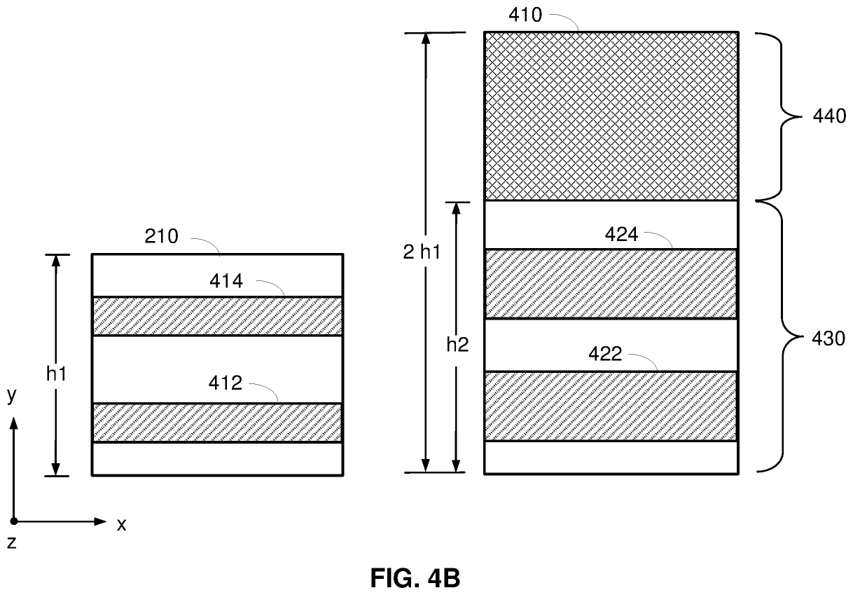

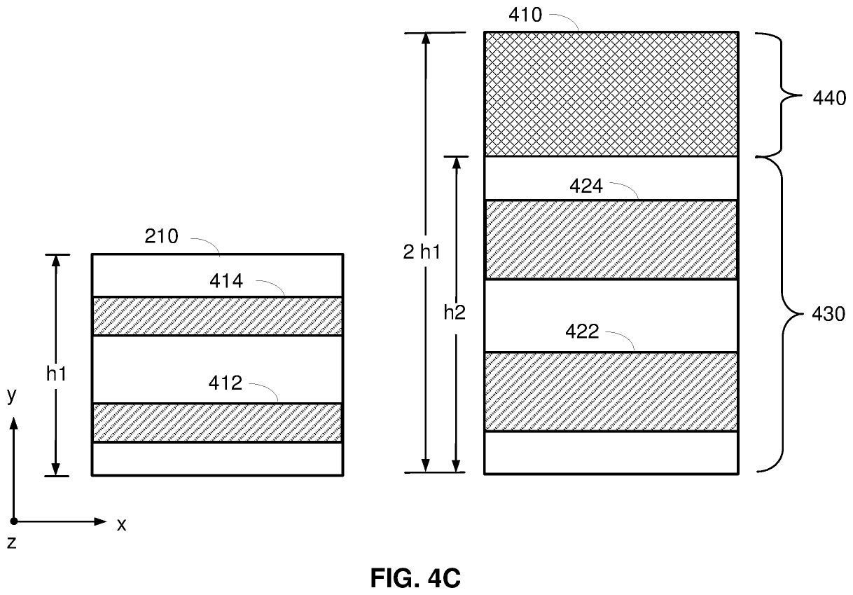

FIG. 4A shows a top view block diagram of the HD cell 210 shown in FIG. 2 and a hybrid HP cell 410 according to aspects of the present disclosure. The HD cell 210 has the first height (labeled “h1”) in the y direction discussed above with reference to FIG. 2. In this example, the hybrid HP cell 410 has a height equal to approximately two times the first height labeled “2h1”). As a result, the height of the hybrid HP cell 410 spans the height of approximately two rows of HD cells. This feature allows the hybrid HP cell 410 to be placed in a circuit including HD cells while maintaining the arrangement of the HD cells in rows, as discussed further below.

FIG. 4B shows an exemplary layout of diffusion regions in the HD cell 210 and the hybrid HP cell 410 according to certain aspects. In this example, the HD cell 210 includes a first diffusion region 412 and a second diffusion region 414 extending in the x direction. The first diffusion region 412 and the second diffusion region 414 are spaced apart from one another in the y direction. The first diffusion region 412 may be n-type and the second diffusion region 414 may be p-type, or vice versa.

The hybrid HP cell 410 includes a first portion 430 and a second portion 440. The first portion 430 includes a first diffusion region 422 and a second diffusion region 424 extending in the x direction. The first diffusion region 422 and the second diffusion region 424 are spaced apart from one another in the y direction. The first diffusion region 422 may be n-type and the second diffusion region 424 may be p-type, or vice versa. The first portion 430 may also be referred to as an active portion of the hybrid HP cell 410.

In this example, each of the diffusion regions 422 and 424 in the hybrid HP cell 410 is wider in the y direction than each of the diffusion regions 412 and 414 in the HD cell 210, as shown in FIG. 4B. The wider diffusion regions 422 and 424 in the hybrid HP cell 410 provide the hybrid HP cell 410 with larger transistors than the HD cell 210 (e.g., for increased drive strength), as discussed further below. For the example of a FinFET process, each of the diffusion regions 422 and 424 in the hybrid HP cell 410 may include a larger number of fins (e.g., fins 180) than each of the diffusion regions 412 and 414 in the HD cell 210. In this example, each of the diffusion regions 412 and 414 may include a first number of fins (e.g., first instance of the fins 180) extending in the x direction, and each of the diffusion regions 422 and 424 may include a second number of fins (e.g., second instance of the fins 180) extending in the x direction where the second number is larger than the first number. For the example of a gate-all-around FET process, each of the diffusion regions 422 and 424 in the hybrid HP cell 410 may include wider channels (e.g., channels 170) in the y direction than each of the diffusion regions 412 and 414 in the HD cell 210. In this example, each of the diffusion regions 412 and 414 may include first channels (e.g., first instance of the channels 170) extending in the x direction, and each of the diffusion regions 422 and 424 may include second channels (e.g., second instance of the channels) extending in the x direction where each of the second channels is wider than each of the first channels in the y direction. In certain aspects, the width of each of the diffusion regions 422 and 424 may be 1.1 to 1.4 times wider than the width of each of the diffusion regions 412 and 414 in the y direction. In another example, each of the diffusion regions 422 and 424 may be between 1.2 to 1.4 times wider than the width of each of the diffusion regions 412 and 414 in the y direction. However, it is to be appreciated that the present disclosure is not limited to these examples.

The first portion 430 of the hybrid HP cell 410 may be approximately equal to the height of the HP cell 220 shown in FIG. 2 (labeled “h2”). In this example, the layout of the first portion 430 of the hybrid HP cell 410 may be the same or substantially the same as the layout of the HP cell 220.

The second portion 440 of the hybrid HP cell 410 may occupy the remaining area of the hybrid HP cell 410. In the example in FIG. 4B, the second portion 440 of the hybrid HP cell 410 increases the height of the hybrid HP cell 410 to a height approximately equal to twice the height of the HD cell 210 (labeled “2h1”). In some implementations, the second portion 440 of the hybrid HP cell 410 may include dummy gates and/or other dummy structures with no active devices. In this example, the second portion 440 of the hybrid HP cell 410 increases the height of the hybrid HP cell 410 (e.g., to a height of approximately 2h1) while the first portion 430 of the hybrid HP cell 410 provides the active devices (e.g., transistors) of the hybrid HP cell 410. The active devices in the first portion 430 of the hybrid HP cell 410 may be the same or substantially the same as the active devices in the HP cell 220. This causes the hybrid HP cell 410 to provide the same or substantially the same performance as the HP cell 220. In this example, the power of the hybrid HP cell 410 is approximately the same as the power of the HP cell 220 assuming the second portion 440 of the hybrid HP cell 410 is non-active.

FIG. 4C shows another exemplary layout of the first diffusion region 422 and the second diffusion region 424 of the hybrid HP cell 410 according to certain aspects. In this example, the widths of the diffusion regions 422 and 424 in the y direction are wider compared with the example in shown in FIG. 4B (e.g., for increased drive strength). The height of the first portion 430 (which includes the active devices of the hybrid HP cell 410) is greater in the example in FIG. 4C than the example in FIG. 4B. For example, the height of the first portion 430 may be approximately equal to 1.2 times the height of the HD cell 210 in the example in FIG. 4B and approximately equal to 1.4 times the height of the HD cell 210 in the example in FIG. 4C. However, it is to be appreciated that the hybrid HP cell 410 is not limited to these examples.

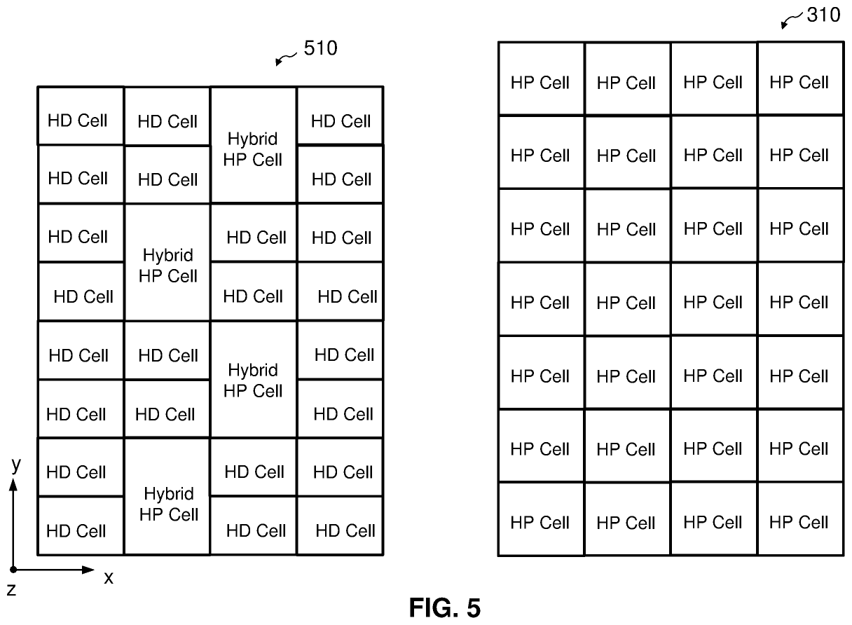

In cases where only a portion of the HD cells in a circuit need to be swapped with high performance cells to meet a desired performance level, the exemplary hybrid HP cell 410 may be used to improve power and area efficiency. In this regard, FIG. 5 shows an example in which four of the HD cells in the group of HD cells 300 shown in FIG. 3 are swapped with four hybrid HP cells to meet a desired performance level according to aspects of the present disclosure. The swap results in the group of HD cells and hybrid HP cells 510 shown in FIG. 5. Each of the hybrid HP cells in the group of HD cells and hybrid HP cells 510 may be a separate instance of the exemplary hybrid HP cell 410. Because the height of each of the hybrid HP cells is approximately equal to twice height of an HD cell, the arrangement of the HD cells in rows is maintained, as shown in FIG. 5. This facilitates the layout of HD cells and hybrid HP cells in the same circuit (e.g., functional block).

FIG. 5 also shows the group of HP cells 310 that resulted from swapping all of the HD cells in the group of HD cells 300 with HP cells. As shown in FIG. 5, the group of HD cells and hybrid HP cells 510 occupies a smaller chip area than the group of HP cells 310. Thus, in this example, swapping four of the HD cells in the group of HD cells 300 with hybrid HP cells results in a smaller increase in area compared will swapping all of the HD cells in the group of HD cells 300 with HP cells.

In this example, each individual hybrid HP cell is larger than each individual HP cell. However, since only a portion of the HD cells in the circuit are being swapped with the hybrid HP cells, using the hybrid HP cells results in a smaller increase in the total area of the circuit (e.g., functional block) compared with swapping all of the HD cells in the circuit with HP cells.

In this example, the hybrid HP cells also reduce power consumption compared with swapping all of the HD cells in the circuit with HP cells. This is because each individual hybrid HP cell consumes approximately the same power as each individual HP cell in this example, as discussed above. Thus, swapping less than all of the HD cells (i.e., less than 100 percent of the HD cells) with hybrid HP cells reduces power consumption compared with swapping all of the HD cells with HP cells. In cases where a small percentage of HD cells are swapped with hybrid HP cells, using the hybrid HP cells can substantially reduce power compared with swapping all of the HD cells with HP cells.

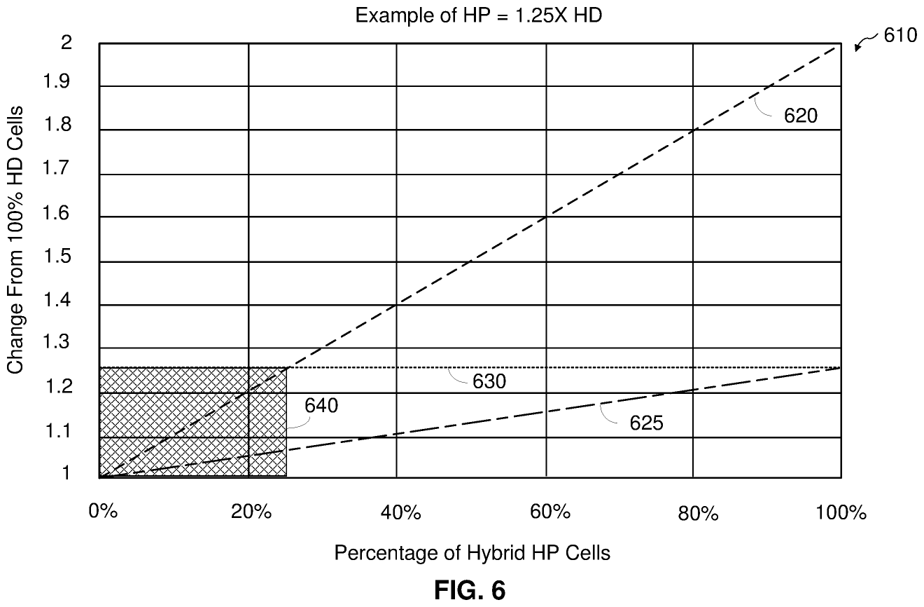

FIG. 6 is a plot 610 showing an example of the change in area and load capacitance of a circuit as a function of the percentage of HD cells in the circuit that are swapped with hybrid HP cells. In this example, the line 620 shows the change in the area of the circuit as a function of the percentage of HD cells that are swapped with hybrid HP cells, in which the vertical axis indicates a ratio of the area of the circuit over the area of the circuit for the case of 100 percent HD cells. As shown in FIG. 6, the area of the circuit increases as the percentage of HD cells that are swapped with hybrid HP cells increases. When all of the HD cells are swapped with hybrid HP cells, the area of the circuit is increased by a factor of two since the height of a hybrid HP cell is twice the height of an HD cell in this example. For comparison, the line 630 shows the area of the circuit for the case where all of the HD cells are swapped with HP cells. In this example, the height of an HP cell is 1.25 times the height of an HD cell.

The line 625 shows the change in the load capacitance of the circuit as a function of the percentage of HD cells in the circuit that are swapped with hybrid HP cells, in which the vertical axis indicates a ratio of the load capacitance of the circuit over the load capacitance of the circuit for the case of 100 percent HD cells. As shown in FIG. 6, the load capacitance increases as the percentage of HD cells that are swapped with hybrid HP cells increases. The increase in the load capacitance translates into an increase in power. When all of the HD cells are swapped with hybrid HP cells, the load capacitance of the circuit is equal to the load capacitance of the circuit for the case where all of the HD cells are swapped with HP cells. Since the load capacitance translates into power, the power of the circuit when all of the HD cells are swapped with hybrid HP cells is approximately equal to the power of the circuit when all of the HD cells are swapped with HP cells.

FIG. 6 shows a benefit zone 640 (shaded area) in which using the hybrid HP cells increases the area and power of the circuit by a smaller amount compared with swapping all of the HD cells with HP cells. In this example, the height of the HP cell is 1.25 times the height of the HD cell. Thus, in this example, using hybrid HP cells increases the area and power of the circuit by a smaller amount when less than 25 percent of the HD cells are swapped with hybrid HP cells. Thus, for cases where less than 25 percent of the HD cells need to be swapped with high performance cells to achieve a desired performance level, using hybrid HP cells provides improved area and power efficiency compared with swapping all of the HD cells with HP cells.

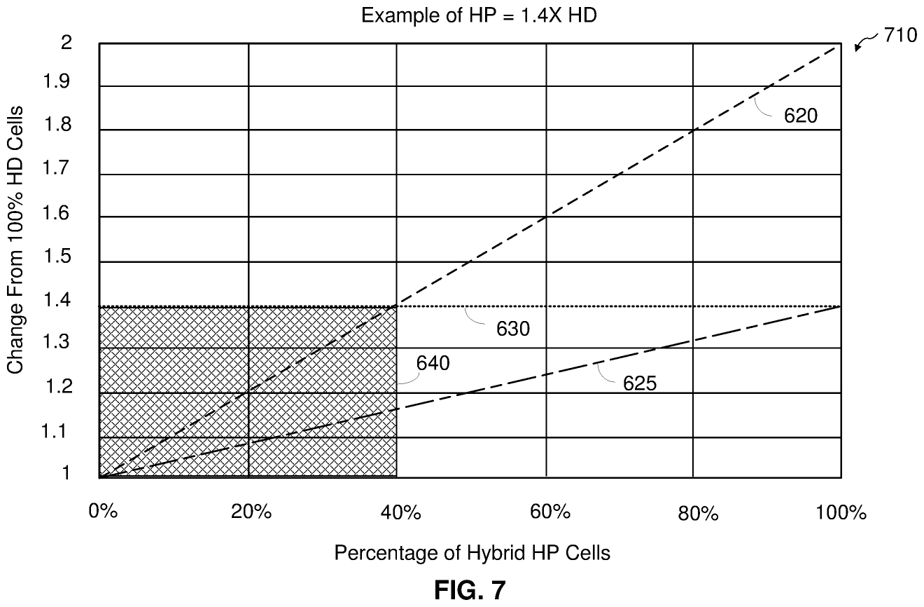

FIG. 7 is plot 710 showing another example of the change in area and load capacitance of the circuit as a function of the percentage of HD cells in the circuit that are swapped with hybrid HP cells. In this example, the height of the HP cell is 1.4 times the height of the HD cell. In this example, the benefit zone 640 (shaded area) is larger compared with FIG. 6 since the height of the HP cell is larger in this example. In this example, using hybrid HP cells increases the area and power of the circuit by a smaller amount compared with swapping all of the HD cells with HP cells when less than 40 percent of the HD cells are swapped with hybrid HP cells. Thus, for cases where less than 40 percent of the HD cells need to be swapped with high performance cells to achieve a desired performance level, using hybrid HP cells provides improved area and power efficiency compared with swapping all of the HD cells with HP cells.

In certain aspects, the standard cell may also include a hybrid HP cell library that defines the layouts of hybrid HP cells that may be placed on the chip 100. Each hybrid HP cell in the hybrid HP cell library may include a first portion (e.g., first portion 430) and a second portion (e.g., second portion 440), in which the first portion has the same or substantially the same layout as a respective HP cell in the HP cell library and the second portion is non-active. Each hybrid HP cell in the hybrid HP cell library may have a height approximately equal to twice the height of an HD cell. However, it is to be appreciated that the present disclosure is not limited to this example. In general, a hybrid HP cell may have a height that is an integer multiple of the height of an HD cell. This allows the hybrid HP cell to be placed next to HD cells on the chip 100 while maintaining the arrangement of the HD cells in rows.

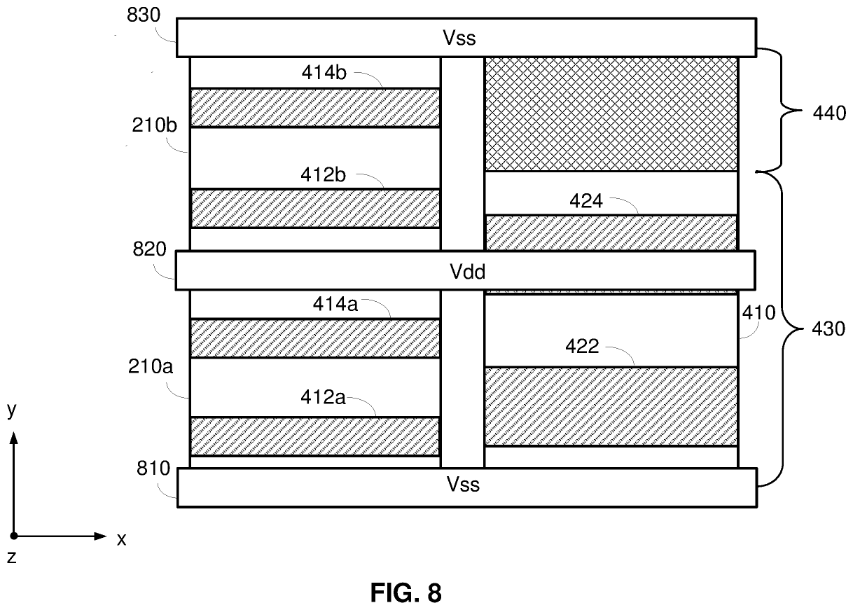

Laying out rails (e.g., supply rails and ground rails) to deliver power to a circuit including HD cells and hybrid HP cells may be challenging. In this regard, FIG. 8 shows an example in which the hybrid HP cell 410 is placed next to a first HD cell 210a and a second HD cell 210b. Each of the HD cells 210a and 210b may be a separate instance of the HD cells 210. In this example, the first HD cell 210a and the second HD cell 210b may lie in different rows of HD cells, where a row extends in the x direction.

FIG. 8 shows an example in which rails that deliver power to the HD cells 210a and 210b are formed (i.e., patterned) from topside metal layer M0. The rails include a first rail 810 (e.g., a ground rail), a second rail 820 (e.g., a supply rail), and a third rail 830 (e.g., a ground rail). A rail may also be referred to as a power bus, a power rail, or another term. The diffusion regions 412a and 414a of the first HD cell 210a are located between the first rail 810 and the second rail 820, and the diffusion regions 412b and 414b of the second HD cell 210b are located between the second rail 820 and the third rail 830.

In this example, the rails 810, 820, and 830 extend in the x direction over the hybrid HP cell 410. The second rail 820 passes over the second diffusion region 424 of the hybrid HP cell 410 due to the wider widths of the diffusion regions 422 and 424 in the hybrid HP cell. Because the second rail 820 passes over the second diffusion region 424, the second rail 820 obstructs signal routing for the second diffusion region 424 in metal layer M0. This obstruction may make it difficult to provide signal routing for the second diffusion region 424 in metal layer M0.

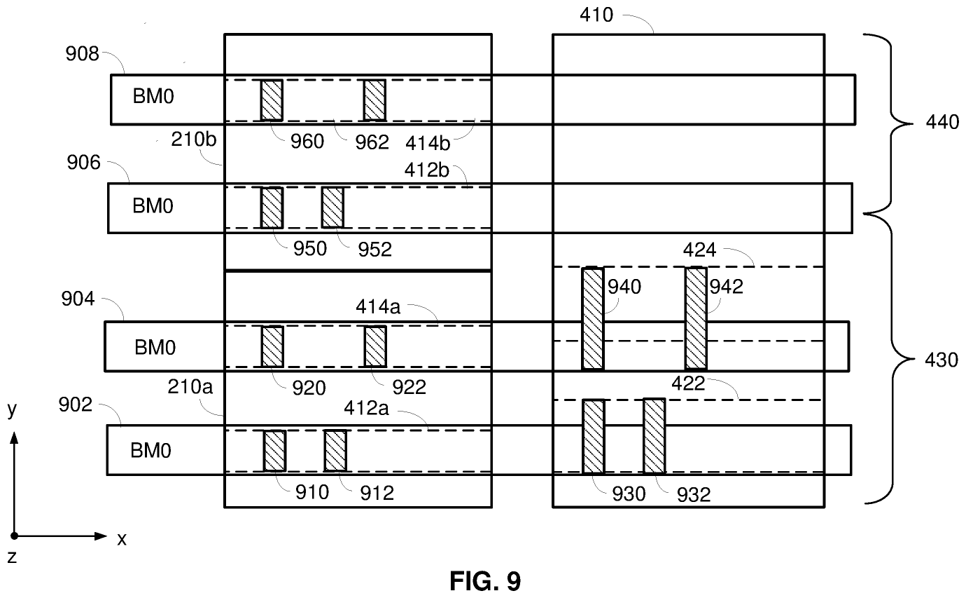

To address this, aspects of the present disclosure use backside metal layer BM0 to provide rails for the HD cells 210a and 210b and the hybrid HP cell 410. Since the rails are formed in backside metal layer BM0, the rails to do not obstruct signal routing for the hybrid HP cell 410 in metal layer M0. In this regard, FIG. 9 shows an example in which the chip 100 includes a first rail 902, a second rail 904, a third rail 906, and a fourth rail 908 formed (i.e., patterned) from backside metal layer BM0 (e.g., using lithography and etching). A side view of backside metal layer BM0 is shown in FIGS. 1A, 1B, 1C, and 1D discussed above. The rails 902, 904, 906, and 908 are spaced apart from one another in the y direction. In FIG. 9, the diffusion regions 422, 424, 412a, 414a, 412b, and 414b of the hybrid HP cell 410 and the HD cells 210a and 210b are shown with dashed lines in order to show the layers underneath the diffusion regions 422, 424, 412a, 414a, 412b, and 414b more clearly.

In this example, the first rail 902 extends under the first diffusion region 412a of the first HD cell 210a in the x direction, and the second 904 extends under the second diffusion region 414a of the first HD cell 210a in the x direction. The first rail 902 may be a ground rail and the second rail 904 may be a supply rail, or vice versa. In this example, the first rail 902 and the second rail 904 also extend under the hybrid HP cell 410 in the x direction. Thus, the first rail 902 and the second rail 904 are contiguous across the first HD cell 210a and the hybrid HP cell 410.

In this example, the third rail 906 extends under the first diffusion region 412b of the second HD cell 210b in the x direction, and the fourth rail 908 extends under the second diffusion region 414b of the second HD cell 210b in the x direction. The third rail 906 may be a ground rail and the fourth rail 908 may be a supply rail, or vice versa. In this example, the third rail 906 and the fourth rail 908 also extend under the hybrid HP cell 410 in the x direction. Thus, the third rail 906 and the fourth rail 908 are contiguous across the second HD cell 210b and the hybrid HP cell 410.

FIG. 9 also shows an example of backside contacts 910, 912, 920, 922, 930, 932, 940, 942, 950, 952, 960, and 962 where each backside contact couples one of the diffusion regions 422, 424, 412a, 414a, 412b, and 414b to one of the rails 902, 904, 906, and 908. The backside contacts 910, 912, 920, 922, 930, 932, 940, 942, 950, 952, 960, and 962 may be formed (i.e., patterned) from backside contact layer BSC shown in FIGS. 1A, 1B, 1C, and 1D (e.g., using lithography and etching). It is to be appreciated that the present disclosure is not limited to the arrangement of backside contacts shown in the example in FIG. 9. It is also to be appreciated that one or more of the backside contacts 910, 912, 920, 922, 930, 932, 940, 942, 950, 952, 960, and 962 shown in the example in FIG. 9 may be omitted.

In this example, the backside contacts 910 and 912 are disposed between a bottom surface of the first diffusion region 412a of the first HD cell 210a and the first rail 902 to couple the first diffusion region 412a to the first rail 902. The backside contacts 920 and 922 are disposed between a bottom surface of the second diffusion region 414a of the first HD cell 210a and the second rail 904 to couple the second diffusion region 414a to the second rail 904. Although FIG. 9 shows an offset between the contacts 912 and 922 in the x direction, it is to be appreciated that the contacts 912 and 922 may be aligned in the x direction.

In this example, the backside contacts 930 and 932 are disposed between a bottom surface of the first diffusion region 422 of the hybrid HP cell 410 and the first rail 902 to couple the first diffusion region 422 to the first rail 902. The backside contacts 940 and 942 are disposed between a bottom surface of the second diffusion region 424 of the hybrid HP cell 410 and the second rail 904 to couple the second diffusion region 424 to the second rail 904. Although FIG. 9 shows an offset between the contacts 932 and 942 in the x direction, it is to be appreciated that the contacts 932 and 942 may be aligned in the x direction.

In this example, the second diffusion region 424 is offset from the second rail 904 in the y direction. This is because the second rail 904 is aligned with the second diffusion region 414a of the first HD cell 210a. In this example, the contacts 940 and 942 extend in the y direction to contact both the second diffusion region 424 and the second rail 904, as shown in FIG. 9.

In this example, the same rails (i.e., the first rail 902 and the second rail 904) are used to deliver power to both the first HD cell 210a and the hybrid HP cell 410. An advantage of using the same rails for HD cells and hybrid HP cells is that the layout of the rails does not have to be changed when HD cells are swapped with hybrid HP cells. In other words, the same layout of rails may be used across HD cells and hybrid HP cells.

In the example shown in FIG. 9, the backside contacts 950 and 952 are disposed between a bottom surface of the first diffusion region 412b of the second HD cell 210b and the third rail 906 to couple the first diffusion region 412b to the third rail 906. The backside contacts 960 and 962 are disposed between a bottom surface of the second diffusion region 414b of the second HD cell 210b and the fourth rail 908 to couple the second diffusion region 414b to the fourth rail 908. In this example, the third rail 906 and the fourth rail 908 extend under the hybrid HP cell 410 in the x direction even through the third rail 906 and the fourth rail 908 are not coupled to a diffusion region in the hybrid HP cell 410 in this example. This may be done so that the layout of the third rail 906 and the fourth rail 908 does not have to be changed when an HD cell receiving power from the third rail 906 and the fourth rail 908 is swapped with the hybrid HP cell 410. In other words, the same layout or pattern of rails can be across HD cells and HP cells. In other implementations, the second diffusion region 424 of the hybrid HP cell 410 may be coupled to the third rail 906 by the backside contacts 940 and 942 instead of the second rail 904. In these implementations, the backside contacts 940 and 942 may extend in the y direction to contact the third rail 906.

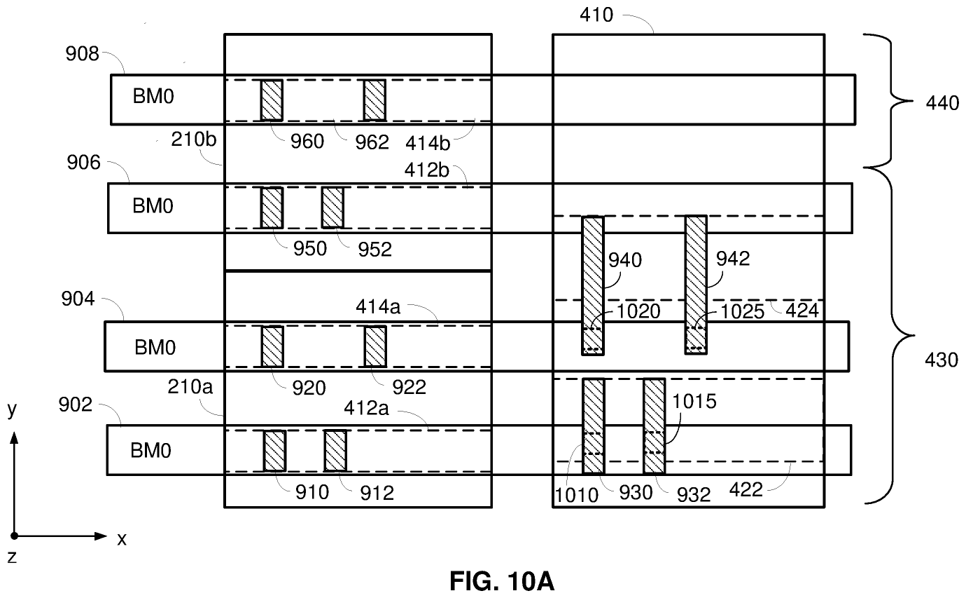

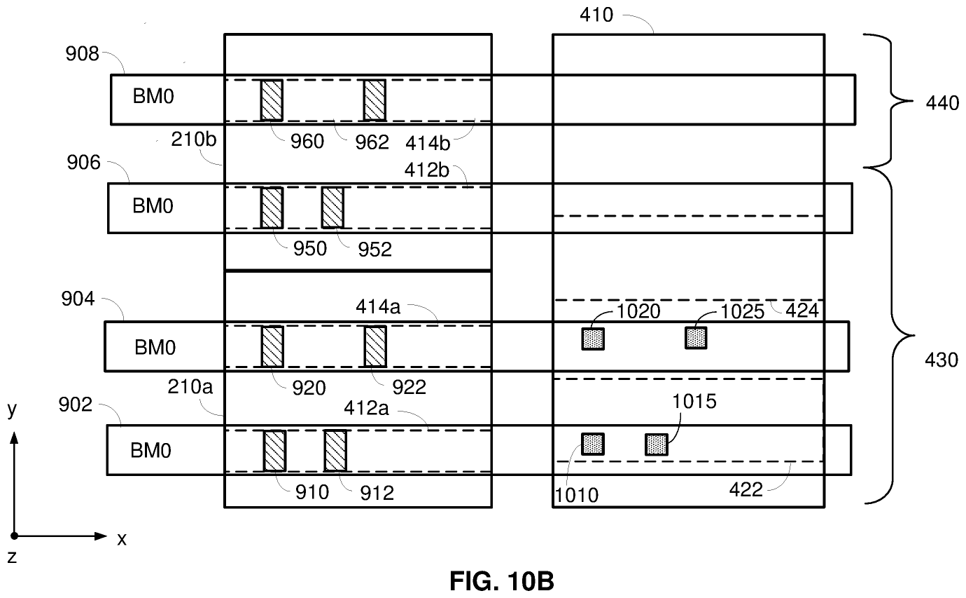

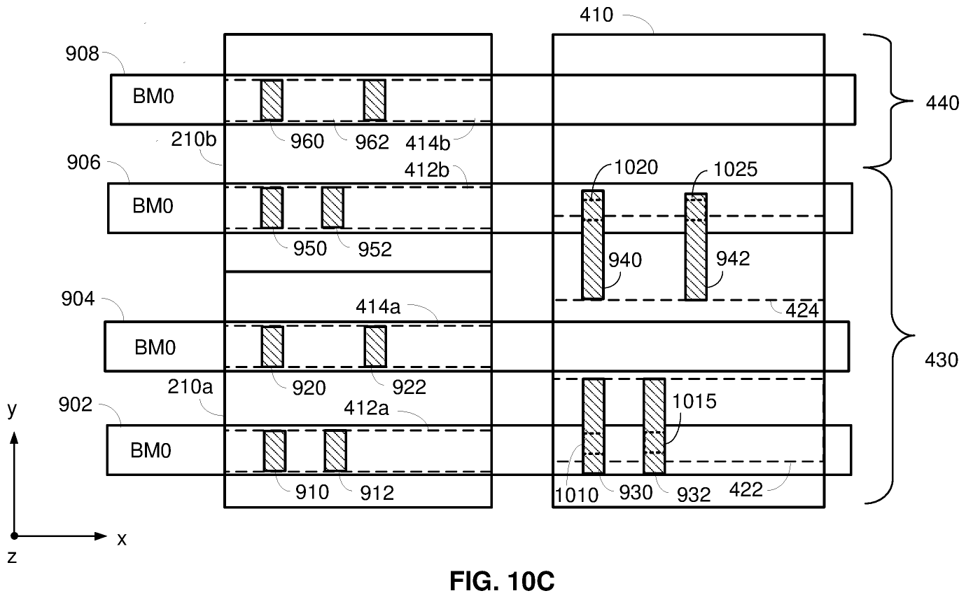

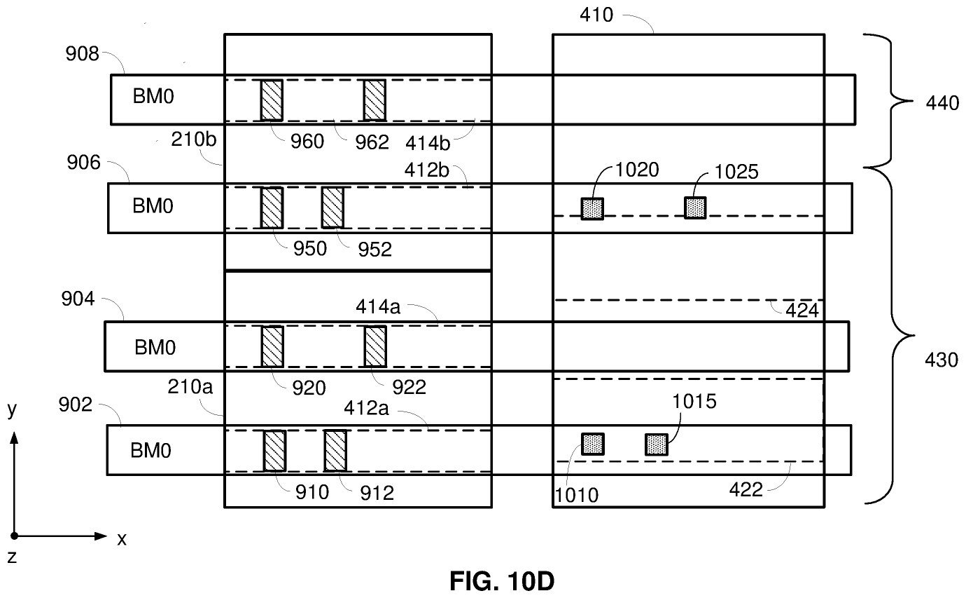

FIG. 10A shows an example in which backside vias 1010 and 1015 are disposed between first rail 902 and the backside contacts 930 and 932, respectively. FIG. 10A also shows an example in which backside vias 1020 and 1025 are disposed between the second rail 904 and the backside contacts 940 and 942, respectively. The backside vias 1010, 1015, 1020, and 1025 may be formed (i.e., patterned) from the same layer as the exemplary backside via 168 shown in FIGS. 1B and 1D. In FIG. 10A, the backside vias 1010, 1015, 1020, and 1025 are shown with dotted lines to indicate that the backside vias 1010, 1015, 1020, and 1025 are under the backside contacts 930, 932, 940, 942, respectively. FIG. 10B shows the backside vias 1010, 1015, 1020, and 1025 with the backside contacts 930, 932, 940, and 942 removed.

In this example, the vias 1010, 1015, 1020, and 1025 provide a space between the backside contacts 930, 932, 940, and 942 and the rails 902 and 904 in the z direction. The space provides greater flexibility in the layout of the diffusion regions 422 and 424 with respect to the rails 902 and 904. For example, in the example in FIG. 10A, the gap between the contacts 930 and 932 and the second rail 904 is small in the y direction. Without the backside vias 1010 and 1015, the contacts 930 and 932 may unintentionally short with the second rail 904 due to process variation and/or violate a minimum spacing requirement specified by a design rule check (DRC). In this example, the backside vias 1010 and 1015 help prevent a potential short between the contacts 930 and 932 and the second rail 904 by providing a space between the contacts 930 and 932 and the second rail 904 in the z direction.

It is to be appreciated that backside vias (not shown) may also be disposed between the backside contacts 910, 912, 920, 922, 950, 952, 960, and 962 and the respective rails 902, 904, 906, and 908 in some implementations.

FIGS. 10C and 10D show an example in which the second diffusion region 424 is coupled to the third rail 906 instead of the second rail 904. In this example, the backside contacts 940 and 942 extend to the third rail 906 in the y direction, and the backside vias 1020 and 1025 are disposed between the third rail 906 and the backside contacts 930 and 932, respectively. In this example, the hybrid HP cell 410 receives power using the first rail 902 and the third rail 906.

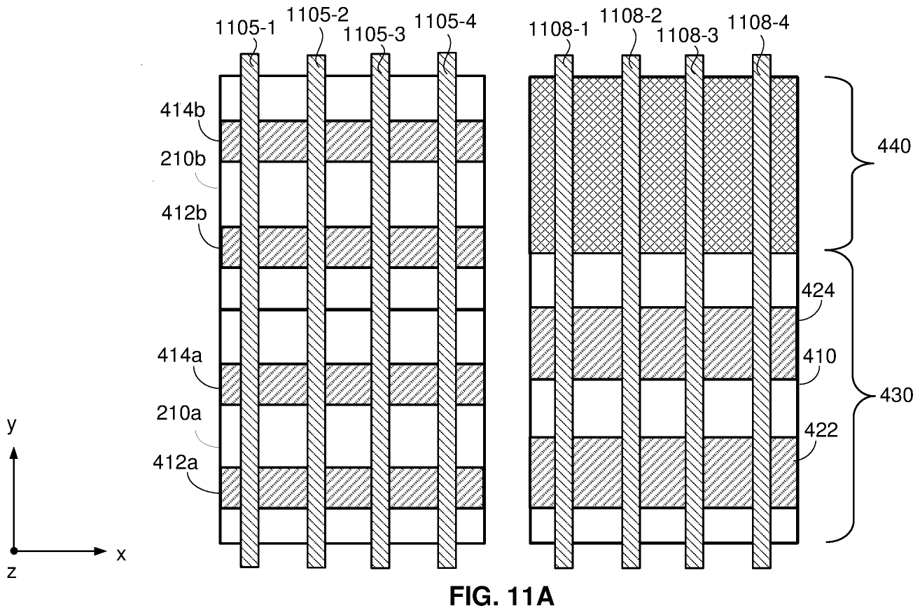

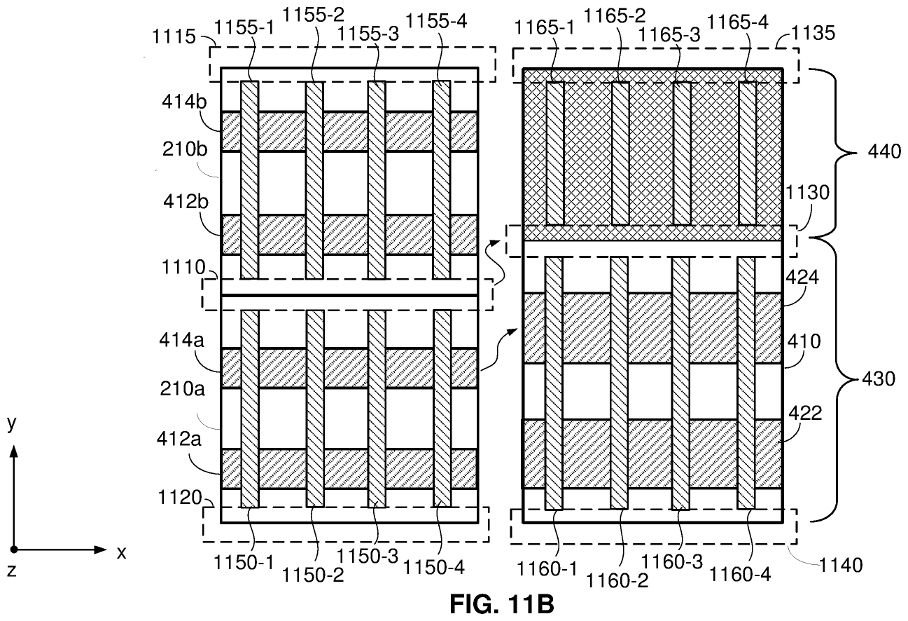

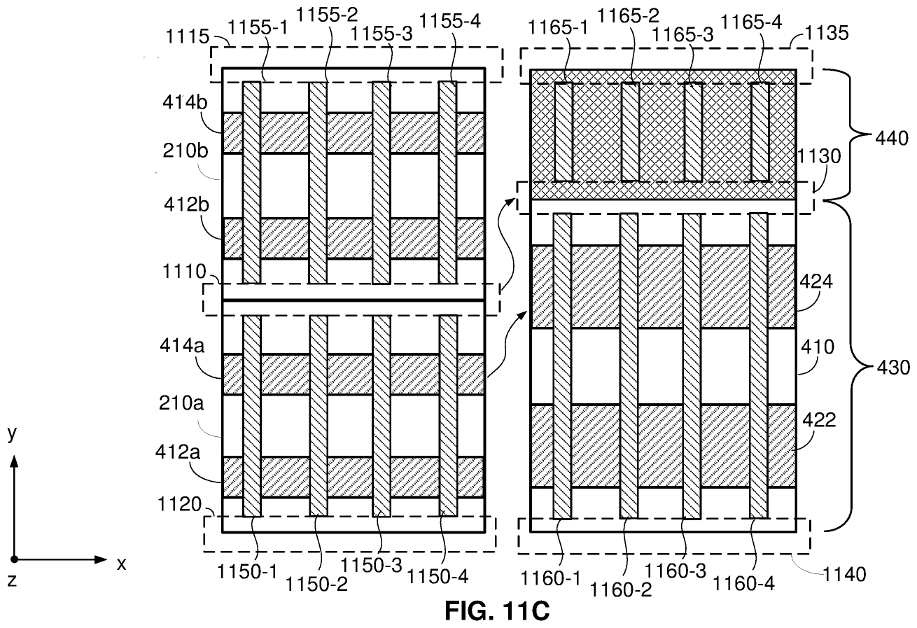

FIG. 11A shows an example of gates 1105-1 to 1105-4 formed on the diffusion regions 412a, 412b, 414a, and 414b of the first HD cell 210a and the second HD cell 210b, and gates 1108-1 to 1108-4 formed on the diffusion regions 422 and 424 of the hybrid HP cell 410. Each of the gates 1105-1 to 1105-4 and 1108-1 to 1108-4 is elongated and extends in the y direction. Each of the gates 1105-1 to 1105-4 and 1108-1 to 1108-4 may include polysilicon, a gate metal, or another gate material. It is to be appreciated that one or more gates (not shown) may also be placed on left and right boundaries of the cells 210a, 210b, and 410.

FIG. 11B shows an example in which the gates 1105-1 to 1105-4 and 1108-1 to 1108-4 in FIG. 11A are cut by gate cuts 1110, 1115, 1120, 1130, 1135, and 1140. The gate cuts may be performed using lithography and etching. In this example, the gate cut 1110 cuts the gates 1105-1 to 1105-4 in FIG. 11A between the diffusion regions 414a and 412b, resulting in gates 1150-1 to 1150-4 in the first HD cell 210a and gates 1155-1 to 1155-4 in the second HD cell 210b. The gates 1150-1 to 1150-4 in the first HD cell 210a are arranged in parallel and extend across the diffusion regions 412a and 414a in the y direction. The gates 1155-1 to 1155-4 in the second HD cell 210b are arranged in parallel and extend across the diffusion regions 412b and 414b in the y direction. For the example where the gates include polysilicon, the gate cuts may also be referred to as poly cuts.

In this example, the gate cut 1130 cuts the gates 1108-1 to 1105-8 in FIG. 11A at the boundary between the first portion 430 and the second portion 440 of the hybrid HP cell 410, resulting in gates 1160-1 to 1160-4 in the first portion 430 and gates 1165-1 to 1165-4 in the second portion 440. The gates 1160-1 to 160-4 are arranged in parallel and extend across the diffusion regions 422 and 424 in the y direction. The gates 1165-1 to 1165-4 in the second portion 440 are arranged in parallel and extend in the y direction. In certain aspects, the gates 1165-1 to 1165-4 may be dummy gates or non-functioning gates.

As shown in FIG. 11B, the second diffusion region 424 of the hybrid HP cell 410 is offset from the second diffusion region 414a of the first HD cell 210a in the y direction. This is because the diffusion regions 422 and 424 of the hybrid HP cell 410 are wider in the y direction (e.g., to increase drive strength) than the diffusion regions 412a and 414a of the first HD cell 210a. As a result, the gate cut 1130 for the hybrid HP cell 410 is offset from the gate cut 1110 in the y direction. The offset (i.e., shift) is indicated by the arrow pointing from the gate cut 1110 to the gate cut 1130 in FIG. 11B. Because of the offset in the gate cuts, the each of the gates 1160-1 to 1160-4 in the hybrid HP cell 410 has a greater height than each of the gates 1150-1 to 1150-4 in the first HD cell 210a in the y direction. In the example shown in FIG. 11B, the height of the first portion 430 of the hybrid HP cell 410 may be equal to 1.2 times the height of each of the HD cells 210a and 210b. However, it is to be appreciated that the present disclosure is not limited to this example.

FIG. 11C shows the gate cut 1130 for another example of the hybrid HP cell 410 in which the diffusion regions 422 and 424 are wider compared with the example shown in FIG. 11B. In this example, the offset (i.e., shift) between the gate cut 1110 and the gate cut 1130 is larger in the y direction due to the wider diffusion regions 422 and 424 in this example. In the example shown in FIG. 11C, the height of the first portion 430 of the hybrid HP cell 410 may be equal to 1.4 times the height of each of the HD cells 210a and 210b. However, it is to be appreciated that the present disclosure is not limited to this example.

In some implementations, a filler cell (not shown) may be placed between the HD cells 210a and 210b and the hybrid HP cell 410 to facilitate a transition from the gate cut 1110 to the gate cut 1130 and/or facilitate a transition from the diffusion regions 412a, 414a, 412b, and 414b in the HD cells 210a to the diffusion regions 422 and 424 in the hybrid HP cell 410. The filler cell may be a non-functioning cell that provides a space between the HD cell 210a and 210b and the hybrid HP cell 410 in the x direction. The filler cell may include one or more non-functioning gates extending in the y direction and spaced apart in the x direction. The pitch between the gates in the filler cell may be the same as the pitch between the gates in the HD cells 210a and 210b and the hybrid HP cell 410 to maintain a uniform gate pitch.

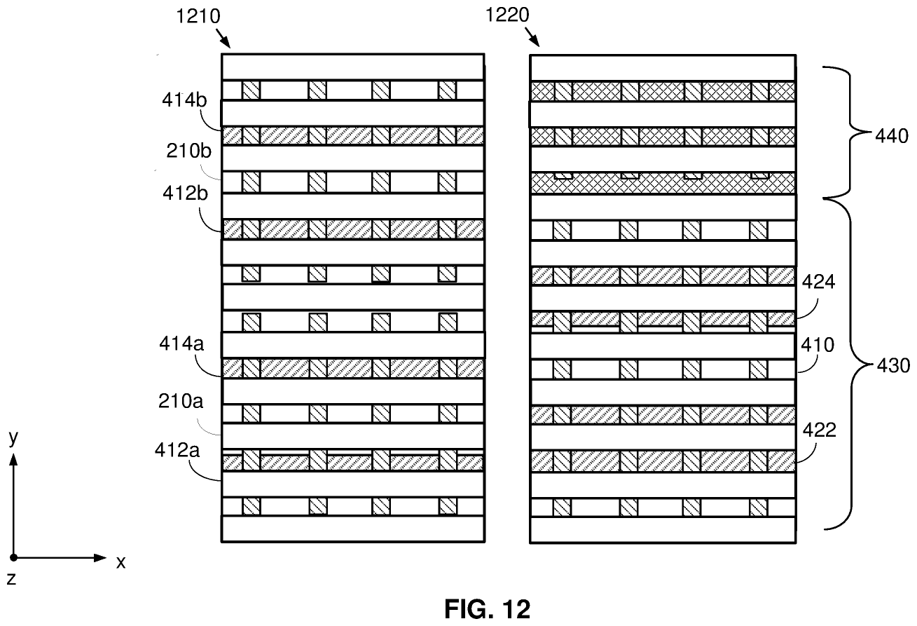

FIG. 12 shows an example of a first set of metal tracks 1210 and a second set of metal tracks 1220 formed (e.g., patterned) from metal layer M0. The first set of metal tracks 1210 may be used for signal routing for the first HD cell 210a and the second HD cell 210b, and the second set of metal tracks 1220 may be used for signal routing for the hybrid HP cell 410. Each metal track in each set of metal tracks extends in the x direction. The metal tracks may be cut to provide signal paths for the HD cells 210a and 210b and the hybrid HP cell 410.

In the example in FIG. 12, the first set of metal tracks 1210 and the second set of metal tracks 1220 have the same pattern, in which the widths of the metal tracks and the spacing between the metal tracks in each set of metal tracks 1210 and 1220 is the same. Since the same pattern of metal tracks is used for HD cells and hybrid HP cells, the pattern of metal tracks does not need to be changed when an HD cell is swapped with a hybrid HP cell. In other words, the pattern of metal tracks (i.e., layout of the metal tracks) is not disrupted when an HD cell is swapped with a hybrid HP cell.

In this example, a metal track may be coupled to one or more gates by one or more vias (e.g., via labeled “VG” in FIGS. 1A, 1B, 1C, and 1D) to provide signal routing for the one or more gates. A metal track may be coupled to a diffusion region by one or more vias (e.g., via labeled “VD” in FIGS. 1A, 1B, 1C, and 1D) to provide signal routing for the diffusion region. A metal track may be coupled to metal layer M1 by one of more vias (e.g., via labeled “V0” in FIGS. 1A, 1B, 1C, and 1D).

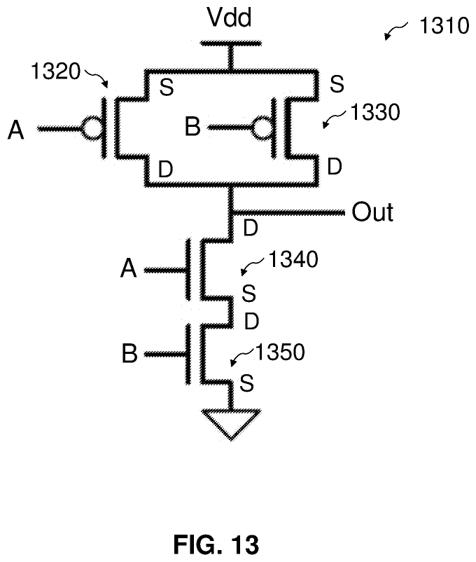

Various types of circuits may be implemented using the HD cells 210a and 210b and the hybrid HP cell 410 including drivers (e.g., complementary inverters), logic gates, combinational logic, latches, and the like. In this regard, FIG. 13 shows an example of a NAND gate 1310 that may be implemented using the HD cells 210a and 210b and the hybrid HP cell 410. However, it is to be appreciated that the HD cells 210a and 210b and the hybrid HP cell 410 are not limited to this example and may be used to implement other types of logic gates (e.g., NOR gates).

In this example, the NAND gate 1310 includes a first transistor 1320, a second transistor 1330, a third transistor 1340, and a fourth transistor 1350. In this example, the first transistor 1320 and the second transistor 1330 are implemented with p-type field effect transistors (PFETs) and the third transistor 1340 and the fourth transistor 1350 are implemented with n-type field effect transistors (NFETs). The drain of each transistor is labeled “D” and the source of each transistor is labeled “S” in FIG. 13.

In this example, the sources of the first transistor 1320 and the second transistor 1330 are coupled to the supply voltage Vdd, the gate of the first transistor 1320 receives a first signal A, and the gate of the second transistor 1330 receives a second signal B. The drains of the first transistor 1320 and the second transistor 1330 are coupled to the output of the NAND gate 1310.

The drain of the third transistor 1340 is coupled to the output of the NAND gate 1310, and the gate of the third transistor 1340 receives the first signal A. The drain of the fourth transistor 1350 is coupled to the source of the third transistor 1340, the gate of the fourth transistor 1350 receives the second signal B, and the source of the fourth transistor 1350 is coupled to ground.

Since the gate of the first transistor 1320 and the gate of the third transistor 1340 both receive the first signal A, the gate of the first transistor 1320 and the gate of the third transistor 1340 may be implemented with a common gate, as discussed further below. Also, since the gate of the second transistor 1330 and the gate of the fourth transistor 1350 both receive the second signal B, the gate of the second transistor 1330 and the gate of the fourth transistor 1350 may be implemented with a common gate.

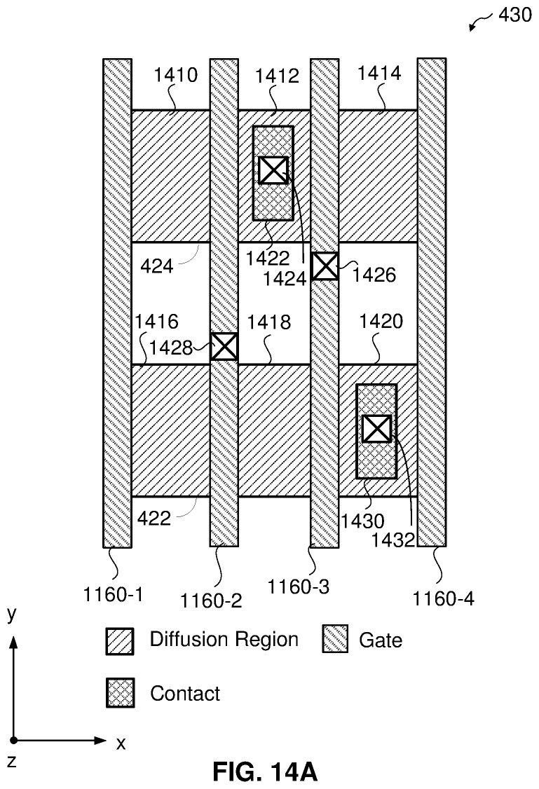

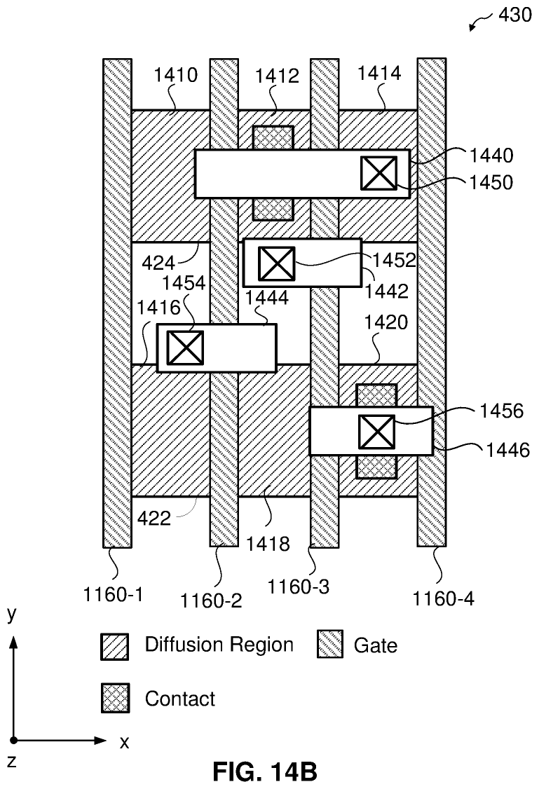

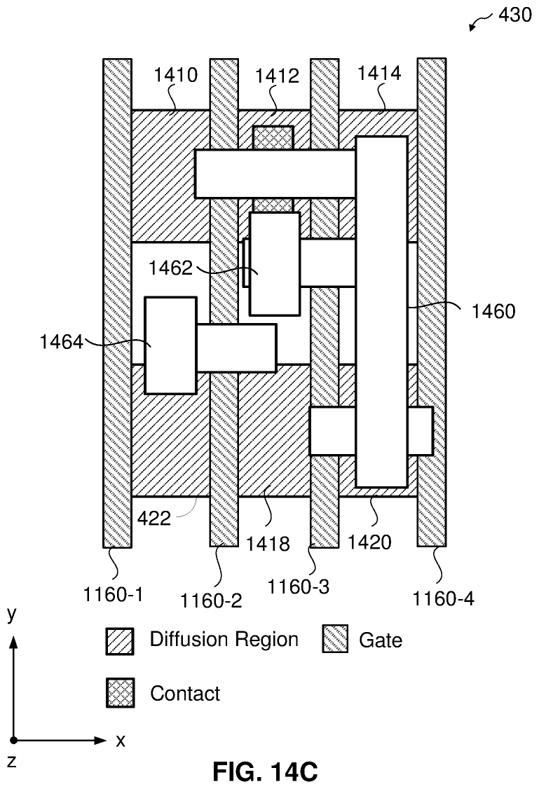

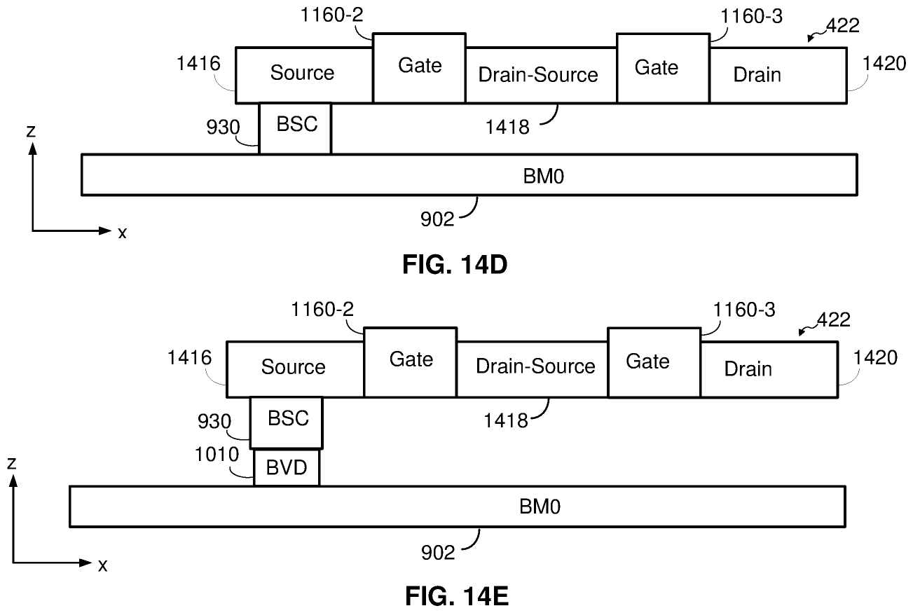

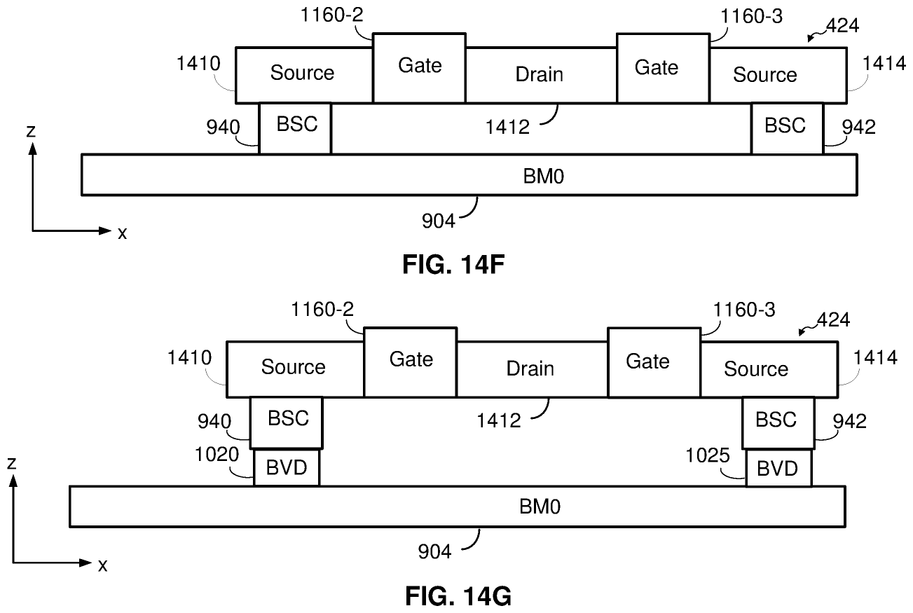

FIGS. 14A to 14C show top views of an exemplary layout for implementing the NAND gate 1310 in the first portion 430 of the hybrid HP cell 410. It is to be appreciated that FIGS. 14A to 14C show an active portion of the hybrid HP cell 410 in which the NAND gate 1310 is implemented, and that the hybrid HP cell 410 may also include a non-active portion that is not shown in FIGS. 14A and 14C. In other words, FIGS. 14A to 14C show a partial layout of the hybrid HP cell 410 focusing on the active portion in which the NAND gate 1310 is implemented.

In this example shown in FIGS. 14A to 14C, the first diffusion region 422 is n-type to implement the third transistor 1340 and the fourth transistor 1350, and the second diffusion region 424 is p-type to implement the first transistor 1320 and the second transistor 1330. The gate 1160-2 provides a common gate for the second transistor 1330 and the fourth transistor 1350, and the gate 1160-3 provides a common gate for the first transistor 1320 and the third transistor 1340.

In this example, a first portion 1410 of the second diffusion region 424 to the left of the gate 1160-2 provides the source of the second transistor 1330, a second portion 1412 of the second diffusion region 424 between the gates 1160-2 and 1160-3 provides the drains of the first transistor 1320 and the second transistor 1330, and a third portion 1414 of the second diffusion region 424 to the right of the gate 1160-3 provides the source of the first transistor 1320. A first portion 1416 of the first diffusion region 422 to the left of the gate 1160-2 provides the source of the fourth transistor 1350, a second portion 1418 of the first diffusion region 422 between the gates 1160-2 and 1160-3 provides the source of the third transistor 1340 and the drain of the fourth transistor 1350, and a third portion 1420 of the first diffusion region 422 to the right of the gate 1160-3 provides the drain of the third transistor 1340.

In this example, a first topside contact 1422 is disposed on the second portion 1412 of the second diffusion region 424, and a second topside contact 1430 is disposed on the third portion 1420 of the first diffusion region 422. The topside contacts 1422 and 1430 may be formed (i.e., patterned) from the topside contact layer labeled “MD” in FIGS. 1A, 1B, 1C, and 1D. FIG. 14A also shows a via 1424 disposed on the first topside contact 1422, a via 1432 disposed on the second topside contact 1430, a via 1426 disposed on the gate 1160-3, and a via 1428 disposed on the gate 1160-2.

FIG. 14B shows metal lines 1440, 1442, 1444, and 1446 formed from the metal tracks 1220 in metal layer M0 shown in FIG. 12. Each of the metal lines 1440, 1442, 1444, and 1446 extends in the x direction. In this example, the metal line 1440 is coupled to the first topside contact 1422 by the vias 1424 (shown in FIG. 14A), and the metal line 1446 is coupled to the second topside contact 1430 by the via 1432 (shown in FIG. 14A). The metal line 1442 is coupled to the gate 1160-3 by the via 1426 (shown in FIG. 14) where the gate 1160-3 provides a common gate for the first transistor 1320 and the third transistor 1340. The metal line 1442 provides signal routing for the common gate of the first transistor 1320 and the third transistor 1340 in metal layer M0. The metal line 1444 is coupled to the gate 1160-2 by the via 1428 (shown in FIG. 14) where the gate 1160-2 provides a common gate for the second transistor 1330 and the fourth transistor 1350. In this example, the metal line 1444 provides signal routing for the common gate of the second transistor 1330 and the fourth transistor 1350 in metal layer M0.

FIG. 14B also shows a via 1450 disposed on the metal line 1440, a via 1452 disposed on the metal line 1442, a via 1454 disposed on the metal line 1444, and a via 1456 disposed on the metal line 1446. The vias 1450, 1452, 1454, and 1456 may be formed from the via layer labeled “V0” in FIGS. 1A, 1B, 1C, and 1D.

FIG. 14C shows metal lines 1460, 1462, and 1464 formed (i.e., patterned) from metal layer M1. Each of the metal lines 1460, 1462, and 1464 extends in the y direction. The metal line 1460 extends across metal lines 1440 and 1446, and is coupled to the metal lines 1440 and 1446 by vias 1450 and 1456 (shown in FIG. 14B), respectively. The metal line 1460 couples the drains of the first transistor 1320 and the second transistor 1330 to the drain of the third transistor 1340. The metal line 1460 also provides signal routing for the output of the NAND gate 1310 in metal layer M1.

The metal line 1462 is coupled to the metal line 1442 the via 1452 (shown in FIG. 14B) and provides signal routing for the first signal A in metal layer M1. The metal line 1464 is coupled to metal line 1444 by via 1454 (shown in FIG. 14B) and provides signal routing for the second signal B in metal layer M1.

It is to be appreciated that the exemplary layout shown in FIGS. 14A to 14C may also be used to implement the NAND gate 1310 using any one of the HD cells 210a and 210b. It is also to be appreciated that the exemplary layout shown in FIGS. 14A to 14C may be flipped in the y direction and/or flipped in the x direction.

As discussed above, the backside metal layers 160 may be used to provide power routing for the HD cells 210a and 210b and the hybrid HP cells. In this regard, FIG. 14D shows a side view of exemplary power routing for the first diffusion region 422 of the hybrid HP cell 410. In this example, the backside contact 930 is disposed between a bottom surface of the first portion 1416 of the first diffusion region 422 and the first rail 902. FIG. 14E shows an example in which the via 1010 is disposed between the backside contact 930 and the first rail 902.

In the examples in FIGS. 14D and 14E, the first portion 1416 of the first diffusion region 422 provides the source of the fourth transistor 1350. However, it is to be appreciated that the present disclosure is not limited to this example, and that the backside contact 930 may be coupled to the source of another transistor. In this example, the first rail 902 may be a ground rail to couple the source of the fourth transistor 1350 to ground. The rail 902 may extend under the first HD cell 210a in the x direction to provide the first HD cell 210a with ground, as shown in FIG. 9.

FIG. 14F shows a side view of exemplary power routing for the second diffusion region 424 of the hybrid HP cell 410. In this example, the backside contact 940 is disposed between a bottom surface of the first portion 1410 of the second diffusion region 424 and the second rail 904, and the backside contact 942 is disposed between a bottom surface of the third portion 1414 of the second diffusion region 424 and the second rail 904. FIG. 14G shows an example in which the via 1020 is disposed between the backside contact 940 and the second rail 904, and the via 1025 is disposed between the backside contact 942 and the second rail 904.

It is to be appreciated that, in other implementations, the backside contact 940 and the backside contact 942 may be coupled to the third rail 906 instead of the second rail 904, as shown in the examples in FIGS. 10C and 10D.

In the examples in FIGS. 14F and 14G, the first portion 1410 of the second diffusion region 424 provides the source of the second transistor 1330 and the third portion 1414 of the second diffusion region 424 provides the source of the first transistor 1320. However, it is to be appreciated that the present disclosure is not limited to this example. In this example, the second rail 904 may be a supply rail to couple the source of the first transistor 1320 and the source of the second transistor 1330 to the supply voltage. The rail 904 may extend under the first HD cell 210a in the x direction to provide the first HD cell 210a with the supply voltage, as shown in FIG. 9.

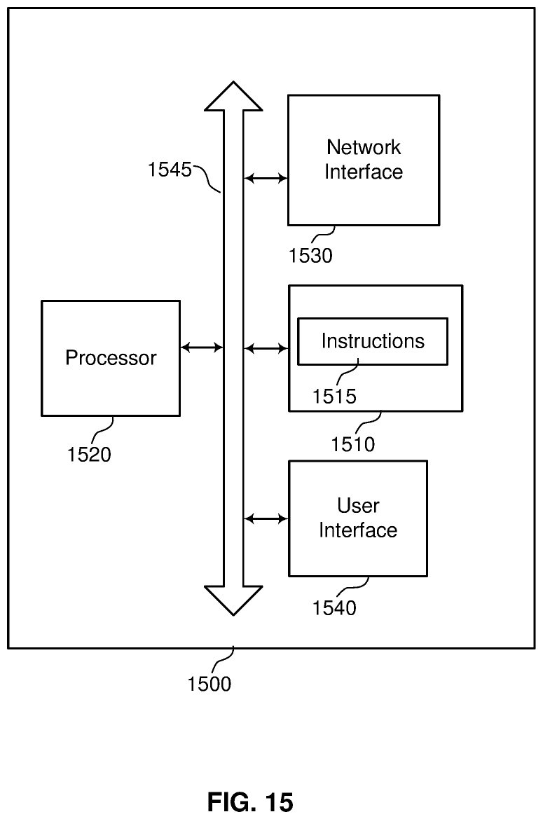

In certain aspects, the exemplary layouts discussed above may be determined using a computer system. In this regard, FIG. 15 illustrates a computer system 1500 that may be used to determine layouts for the chip 100 according to certain aspects. The computer system 1500 may include a processor 1520, a memory 1510, a network interface 1530, and a user interface 1540. These components may be in electronic communication via one or more buses 1545.

The memory 1510 may store instructions 1515 that are executable by the processor 1520 to cause the computer system 1500 to perform one or more of the operations described herein. The processor 1520 may include a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or any combination thereof.

The memory 1510 may include, by way of example, random access memory (RAM), flash memory, read only memory (ROM), programmable read only memory (PROM), erasable programmable read only memory (EPROM), electrically erasable programmable read only memory (EEPROM), registers, magnetic disks, optical disks, hard drives, or any other suitable storage medium, or any combination thereof. The memory 1510 may also store a cell library including files specifying layouts for various cells that may be placed on the chip 100 including layouts of HD cells (e.g., HD cells 210, 210a, and 210b) and layouts of hybrid HP cells (e.g., hybrid HP cell 410).

The network interface 1530 is configured to interface the computer system 1500 with one or more other devices. The user interface 1540 may be configured to receive data from a user (e.g., via keypad, mouse, etc.) and provide the data to the processor 1520. The user interface 1540 may also be configured to output data from the processor 1520 to the user (e.g., via a display, a speaker, etc.).

Implementation examples are described in the following numbered clauses:

1. A chip, comprising:
a first cell comprising:
   a first diffusion region extending in a first direction; and
   a first backside contact coupled to a bottom surface of the first diffusion region;
a second cell comprising:
   a second diffusion region extending in the first direction, wherein the second diffusion region is wider than the first diffusion region in a second direction perpendicular to the first direction; and
   a second backside contact coupled to a bottom surface of the second diffusion region; and
a power rail extending under the first cell and the second cell in the first direction, wherein the power rail is coupled to the first backside contact and the second backside contact.

2. The chip of clause 1, further comprising:
a first via disposed between the first backside contact and the power rail; and
a second via disposed between the second backside contact and the power rail.

3. The chip of clause 1 or 2, wherein the second diffusion region is between 1.1 to 1.4 times wider than the first diffusion region in the second direction.

4. The chip of clause 3, wherein the second diffusion region is offset from the first diffusion region in the second direction.

5. The chip of any one of clauses 1 to 4, wherein:
the first cell comprises first gates formed on the first diffusion region, wherein each of the first gates extends across the first diffusion region in the second direction; and
the second cell comprises second gates formed on the second diffusion region, wherein each of the second gates extends across the second diffusion region in the second direction.

6. The chip of clause 5, wherein a height of each of the second gates in the second direction is greater than a height of each of the first gates in the second direction.

7. The chip of any one of clauses 1 to 6, wherein a height of the second cell in the second direction is approximately two times a height of the first cell in the second direction.

8. The chip of any one of clauses 1 to 7, wherein the power rail is a supply rail configured to provide a supply voltage.

9. The chip of any one of clauses 1 to 7, wherein the power rail is a ground rail.

10. The chip of any one of clauses 1 to 9, wherein the power rail is formed from a backside metal layer.

11. A chip, comprising:
a first cell comprising:
   a first diffusion region extending in a first direction; and
   a second diffusion region extending in the first direction;
a second cell comprising:
   a third diffusion region extending in the first direction; and
   a fourth diffusion region extending in the first direction, wherein each of the third diffusion region and the fourth diffusion region is wider than each of the first diffusion region and the second diffusion region in a second direction perpendicular to the first direction;
a first power rail extending under the first cell and the second cell in the first direction, wherein the first power rail is coupled to a bottom surface of the first diffusion region and a bottom surface of the third diffusion region; and
a second power rail extending under the first cell and the second cell in the first direction, wherein the second power rail is coupled to a bottom surface of the second diffusion region and a bottom surface of the fourth diffusion region.

12. The chip of clause 11, wherein each of the third diffusion region and the fourth diffusion region is between 1.1 to 1.4 times wider than each of the first diffusion region and the second diffusion region in the second direction.

13. The chip of clause 11 or 12, wherein a height of the second cell in the second direction is approximately two times a height of the first cell in the second direction.

14. The chip of any one of clauses 11 to 13, wherein:
the first cell comprises first gates formed on the first diffusion region and the second diffusion region, wherein each of the first gates extends across the first diffusion region and the second region diffusion region in the second direction; and
the second cell comprises second gates formed on the third diffusion region and the fourth diffusion region, wherein each of the second gates extends across the third diffusion region and the fourth diffusion region in the second direction.

15. The chip of clause 14, wherein a height of each of the second gates in the second direction is a greater than a height of each of the first gates in the second direction.

16. The chip of clause 15, wherein:
each of the first diffusion region and the third diffusion region is n-type;
each of the second diffusion region and the fourth diffusion region in p-type;
the first power rail is a ground rail; and
the second power rail is a supply rail configured to provide a supply voltage.

17. A chip, comprising:
a first cell comprising:
   a first diffusion region extending in a first direction; and
   a second diffusion region extending in the first direction;
a second cell comprising:
   a third diffusion region extending in the first direction; and
   a fourth diffusion region extending in the first direction;
a third cell comprising:
   a fifth diffusion region extending in the first direction; and
   a sixth diffusion region extending in the first direction, wherein each of the fifth diffusion region and the sixth diffusion region is wider than each of the first diffusion region, the second diffusion region, the third diffusion region, and the fourth diffusion region in a second direction perpendicular to the first direction;
a first power rail extending under the first cell and the third cell in the first direction, wherein the first power rail is coupled to a bottom surface of the first diffusion region and a bottom surface of the fifth diffusion region;
a second power rail extending under the first cell and the third cell in the first direction, wherein the second power rail is coupled to a bottom surface of the second diffusion region;
a third power rail extending under the second cell and the third cell in the first direction, wherein the third power rail is coupled to a bottom surface of the third diffusion region and a bottom surface of the sixth diffusion region; and
a fourth power rail extending under the second cell and the third cell in the first direction, wherein the fourth power rail is coupled to a bottom surface of the fourth diffusion region.

18. The chip of clause 17, wherein each of the fifth diffusion region and the sixth diffusion region is between 1.1 to 1.4 times wider than each of the first diffusion region, the second diffusion region, the third diffusion region, and the fourth diffusion region in the second direction.

19. The chip of clause 17 or 18, wherein a height of the third cell in the second direction is approximately two times a height of each of the first cell and the second cell in the second direction.

20. The chip of any one of clauses 17 to 19, wherein the first power rail, the second power rail, the third power rail, and the fourth power rail are spaced apart from one another in the second direction.

21. The chip of any one of clauses 17 to 20, wherein:
the first cell comprises first gates formed on the first diffusion region and the second diffusion region, wherein each of the first gates extends across the first diffusion region and the second region diffusion region in the second direction;
the second cell comprises second gates formed on the third diffusion region and the fourth diffusion region, wherein each of the second gates extends across the third diffusion region and the fourth diffusion region in the second direction; and
the third cell comprises third gates formed on the fifth diffusion region and the sixth diffusion region, wherein each of the third gates extends across the fifth diffusion region and the sixth diffusion region in the second direction.

22. The chip of clause 21, wherein a height of each of the third gates in the second direction is a greater than a height of each of the first gates in the second direction.

23. The chip of clause 21 or 22, wherein the second diffusion region is between the first diffusion region and the third diffusion region.

24. A chip, comprising:
a first diffusion region extending in a first direction;
a second diffusion region extending in the first direction;
a third diffusion region extending in the first direction;
a fourth diffusion region extending in the first direction, wherein each of the third diffusion region and the fourth diffusion region is wider than each of the first diffusion region and the second diffusion region in a second direction perpendicular to the first direction;
a first power rail extending under the first diffusion region in the first direction, wherein the first power rail is coupled to a bottom surface of the first diffusion region and a bottom surface of the third diffusion region; and
a second power rail extending under the second diffusion region in the first direction, wherein the second power rail is coupled to a bottom surface of the second diffusion region and a bottom surface of the fourth diffusion region.

25. The chip of clause 24, wherein each of the third diffusion region and the fourth diffusion region is between 1.1 to 1.4 times wider than each of the first diffusion region and the second diffusion region in the second direction.

26. The chip of clause 24 or 25, further comprising:
first gates formed on the first diffusion region and the second diffusion region, wherein each of the first gates extends across the first diffusion region and the second region diffusion region in the second direction; and
second gates formed on the third diffusion region and the fourth diffusion region, wherein each of the second gates extends across the third diffusion region and the fourth diffusion region in the second direction.

27. The chip of clause 26, wherein a height of each of the second gates in the second direction is a greater than a height of each of the first gates in the second direction.

28. The chip of any one of clauses 24 to 27, wherein:
each of the first diffusion region and the third diffusion region is n-type;
each of the second diffusion region and the fourth diffusion region in p-type;
the first power rail is a ground rail; and
the second power rail is a supply rail configured to provide a supply voltage.

29. A chip, comprising:
a first diffusion region extending in a first direction; and
a second diffusion region extending in the first direction;
a third diffusion region extending in the first direction;
a fourth diffusion region extending in the first direction;
a fifth diffusion region extending in the first direction;
a sixth diffusion region extending in the first direction, wherein each of the fifth diffusion region and the sixth diffusion region is wider than each of the first diffusion region, the second diffusion region, the third diffusion region, and the fourth diffusion region in a second direction perpendicular to the first direction;
a first power rail extending under the first diffusion region in the first direction, wherein the first power rail is coupled to a bottom surface of the first diffusion region and a bottom surface of the fifth diffusion region;
a second power rail extending under the second diffusion region in the first direction, wherein the second power rail is coupled to a bottom surface of the second diffusion region;
a third power rail extending under the third diffusion region in the first direction, wherein the third power rail is coupled to a bottom surface of the third diffusion region and a bottom surface of the sixth diffusion region; and
a fourth power rail extending under the fourth diffusion region in the first direction, wherein the fourth power rail is coupled to a bottom surface of the fourth diffusion region.

30. The chip of clause 29, wherein each of the fifth diffusion region and the sixth diffusion region is between 1.1 to 1.4 times wider than each of the first diffusion region, the second diffusion region, the third diffusion region, and the fourth diffusion region in the second direction.

31. The chip of clause 29 or 30, wherein the first power rail, the second power rail, the third power rail, and the fourth power rail are spaced apart from one another in the second direction.

32. The chip of clause 31, wherein the second power rail is between the first power rail and the third power rail in the second direction.

33. The chip of any one of clauses 29 to 32, further comprising:
first gates formed on the first diffusion region and the second diffusion region, wherein each of the first gates extends across the first diffusion region and the second region diffusion region in the second direction;
second gates formed on the third diffusion region and the fourth diffusion region, wherein each of the second gates extends across the third diffusion region and the fourth diffusion region in the second direction; and
third gates formed on the fifth diffusion region and the sixth diffusion region, wherein each of the third gates extends across the fifth diffusion region and the sixth diffusion region in the second direction.

34. The chip of clause 33, wherein a height of each of the third gates in the second direction is a greater than a height of each of the first gates in the second direction.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect electrical coupling between two structures. As used herein, the term “approximately” means within 90 percent to 110 percent of the stated value.

Any reference to an element herein using a designation such as “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A chip, comprising:
a first cell comprising:
a first diffusion region extending in a first direction; and
a first backside contact coupled to a bottom surface of the first diffusion region;
a second cell comprising:
a second diffusion region extending in the first direction, wherein the second diffusion region is wider than the first diffusion region in a second direction perpendicular to the first direction; and
a second backside contact coupled to a bottom surface of the second diffusion region; and
a power rail extending under the first cell and the second cell in the first direction, wherein the power rail is coupled to the first backside contact and the second backside contact.

2. The chip of claim 1, further comprising:
a first via disposed between the first backside contact and the power rail; and
a second via disposed between the second backside contact and the power rail.

3. The chip of claim 1, wherein the second diffusion region is between 1.1 to 1.4 times wider than the first diffusion region in the second direction.

4. The chip of claim 3, wherein the second diffusion region is offset from the first diffusion region in the second direction.

5. The chip of claim 1, wherein:
the first cell comprises first gates formed on the first diffusion region, wherein each of the first gates extends across the first diffusion region in the second direction; and
the second cell comprises second gates formed on the second diffusion region, wherein each of the second gates extends across the second diffusion region in the second direction.

6. The chip of claim 5, wherein a height of each of the second gates in the second direction is greater than a height of each of the first gates in the second direction.

7. The chip of claim 1, wherein a height of the second cell in the second direction is approximately two times a height of the first cell in the second direction.

8. The chip of claim 1, wherein the power rail is a supply rail configured to provide a supply voltage.

9. The chip of claim 1, wherein the power rail is a ground rail.

10. The chip of claim 1, wherein the power rail is formed from a backside metal layer.

11. A chip, comprising:
a first cell comprising:
a first diffusion region extending in a first direction; and
a second diffusion region extending in the first direction;
a second cell comprising:
a third diffusion region extending in the first direction; and
a fourth diffusion region extending in the first direction, wherein each of the third diffusion region and the fourth diffusion region is wider than each of the first diffusion region and the second diffusion region in a second direction perpendicular to the first direction;
a first power rail extending under the first cell and the second cell in the first direction, wherein the first power rail is coupled to a bottom surface of the first diffusion region and a bottom surface of the third diffusion region; and
a second power rail extending under the first cell and the second cell in the first direction, wherein the second power rail is coupled to a bottom surface of the second diffusion region and a bottom surface of the fourth diffusion region.

12. The chip of claim 11, wherein each of the third diffusion region and the fourth diffusion region is between 1.1 to 1.4 times wider than each of the first diffusion region and the second diffusion region in the second direction.

13. The chip of claim 11, wherein a height of the second cell in the second direction is approximately two times a height of the first cell in the second direction.

14. The chip of claim 11, wherein:
the first cell comprises first gates formed on the first diffusion region and the second diffusion region, wherein each of the first gates extends across the first diffusion region and the second region diffusion region in the second direction; and
the second cell comprises second gates formed on the third diffusion region and the fourth diffusion region, wherein each of the second gates extends across the third diffusion region and the fourth diffusion region in the second direction.

15. The chip of claim 14, wherein a height of each of the second gates in the second direction is a greater than a height of each of the first gates in the second direction.

16. The chip of claim 15, wherein:
each of the first diffusion region and the third diffusion region is n-type;
each of the second diffusion region and the fourth diffusion region in p-type;
the first power rail is a ground rail; and
the second power rail is a supply rail configured to provide a supply voltage.

17. A chip, comprising:
a first cell comprising:
a first diffusion region extending in a first direction; and
a second diffusion region extending in the first direction;
a second cell comprising:
a third diffusion region extending in the first direction; and
a fourth diffusion region extending in the first direction;
a third cell comprising:
a fifth diffusion region extending in the first direction; and
a sixth diffusion region extending in the first direction, wherein each of the fifth diffusion region and the sixth diffusion region is wider than each of the first diffusion region, the second diffusion region, the third diffusion region, and the fourth diffusion region in a second direction perpendicular to the first direction;
a first power rail extending under the first cell and the third cell in the first direction, wherein the first power rail is coupled to a bottom surface of the first diffusion region and a bottom surface of the fifth diffusion region;
a second power rail extending under the first cell and the third cell in the first direction, wherein the second power rail is coupled to a bottom surface of the second diffusion region;
a third power rail extending under the second cell and the third cell in the first direction, wherein the third power rail is coupled to a bottom surface of the third diffusion region and a bottom surface of the sixth diffusion region; and
a fourth power rail extending under the second cell and the third cell in the first direction, wherein the fourth power rail is coupled to a bottom surface of the fourth diffusion region.

18. The chip of claim 17, wherein each of the fifth diffusion region and the sixth diffusion region is between 1.1 to 1.4 times wider than each of the first diffusion region, the second diffusion region, the third diffusion region, and the fourth diffusion region in the second direction.

19. The chip of claim 17, wherein a height of the third cell in the second direction is approximately two times a height of each of the first cell and the second cell in the second direction.

20. The chip of claim 17, wherein the first power rail, the second power rail, the third power rail, and the fourth power rail are spaced apart from one another in the second direction.

21. The chip of claim 17, wherein:
the first cell comprises first gates formed on the first diffusion region and the second diffusion region, wherein each of the first gates extends across the first diffusion region and the second region diffusion region in the second direction;
the second cell comprises second gates formed on the third diffusion region and the fourth diffusion region, wherein each of the second gates extends across the third diffusion region and the fourth diffusion region in the second direction; and
the third cell comprises third gates formed on the fifth diffusion region and the sixth diffusion region, wherein each of the third gates extends across the fifth diffusion region and the sixth diffusion region in the second direction.

22. The chip of claim 21, wherein a height of each of the third gates in the second direction is a greater than a height of each of the first gates in the second direction.

23. The chip of claim 21, wherein the second diffusion region is between the first diffusion region and the third diffusion region.

24. A chip, comprising:
a first diffusion region extending in a first direction;
a second diffusion region extending in the first direction;
a third diffusion region extending in the first direction;
a fourth diffusion region extending in the first direction, wherein each of the third diffusion region and the fourth diffusion region is wider than each of the first diffusion region and the second diffusion region in a second direction perpendicular to the first direction;
a first power rail extending under the first diffusion region in the first direction, wherein the first power rail is coupled to a bottom surface of the first diffusion region and a bottom surface of the third diffusion region; and
a second power rail extending under the second diffusion region in the first direction, wherein the second power rail is coupled to a bottom surface of the second diffusion region and a bottom surface of the fourth diffusion region.

25. The chip of claim 24, wherein each of the third diffusion region and the fourth diffusion region is between 1.1 to 1.4 times wider than each of the first diffusion region and the second diffusion region in the second direction.

26. The chip of claim 24, further comprising:
first gates formed on the first diffusion region and the second diffusion region, wherein each of the first gates extends across the first diffusion region and the second region diffusion region in the second direction; and
second gates formed on the third diffusion region and the fourth diffusion region, wherein each of the second gates extends across the third diffusion region and the fourth diffusion region in the second direction.

27. The chip of claim 26, wherein a height of each of the second gates in the second direction is a greater than a height of each of the first gates in the second direction.

28. The chip of claim 24, wherein:
each of the first diffusion region and the third diffusion region is n-type;
each of the second diffusion region and the fourth diffusion region in p-type;
the first power rail is a ground rail; and
the second power rail is a supply rail configured to provide a supply voltage.
